(19) United States
(12) Patent Application Publication
(10) Pub. No.: US 2016/0004231 A1
(43) Pub. Date: Jan. 7, 2016

(54) METHOD OF MANAGING ELECTRICAL DEVICE, MANAGING SYSTEM, ELECTRICAL DEVICE, OPERATION TERMINAL, AND PROGRAM

(71) Applicant: PANASONIC INTELLECTUAL PROPERTY MANAGEMENT CO., LTD., Osaka (JP)

(72) Inventors: Yasuo YOSHIMURA, Shiga (JP); Daisaku KITAGAWA, Osaka (JP)

(73) Assignee: Panasonic Intellectual Property Management Co., Ltd., Osaka-shi, Osaka (JP)

(21) Appl. No.: 14/416,199

(22) PCT Filed: Mar. 10, 2014
(86) PCT No.: PCT/JP2014/001343

§ 371 Date: Jan. 21, 2015

(30) Foreign Application Priority Data
Jul. 25, 2013 (JP) 2013-154255

(51) Int. Cl. G05B 15/02; H04W 4/00

(52) U.S. Cl. CPC G05B 15/02; H04W 4/008

(57) ABSTRACT

In a method of managing an electrical device, details of at least one operation performed using any one of one or more operation terminals to operate an electrical device are stored (S800); and when a state of running of the electrical device is displayed according to the details of at least one operation that are stored (S810), (i) information indicating which one of the one or more operation terminals has been used in operating the running and (ii) information indicating whether or not the details of at least one operation for the running have been performed using, among the one or more operation terminals, one operation terminal that is present in a same home as the electrical device are presented (S820, S830).

### TECHNICAL FIELD

The present invention relates to a method of managing an electrical device, a managing system, an electrical device, an operation terminal, and a program.

### BACKGROUND ART

In recent years, as described in Patent Literature (PTL) 1, techniques related to a safety confirmation service have been disclosed. The safety confirmation service allows information of operation history of electrical devices such as a television set at a home of a user to be transmitted to a family member or the like of the user, thereby allowing the family member or the like who lives in a home different from the home of the user to know the living situation of the user from the operation history or an operation state of the electrical devices of the user.

Possible electrical devices to be a target of the safety confirmation service include a television set, an electric kettle, a refrigerator, an air conditioner, and the like, which are indispensable in everyday life. For example, by viewing the operation history of an air conditioner installed in a home of a user, it is possible to determine that a user has been living in the home at the time when the operation was carried out, making it possible for a family member to watch for an abnormality of the user.

### CITATION LIST

### Patent Literature

[PTL 1] Japanese Unexamined Patent Application Publication No. 2007-258939

### SUMMARY OF INVENTION

### Technical Problem

However, there is a problem that it is difficult to determine, for example, a place at which the electrical device was operated.

In view of the above, the present invention provides a method of managing an electrical device which provides information related to a place at which the electrical device was operated, as and the like.

### Solution to Problem

In order to solve the above-described problem, a method of managing according to an aspect of the present invention is a method of managing an electrical device, including: storing details of at least one operation performed using any one of one or more operation terminals to operate an electrical device; and when a state of running of the electrical device is displayed according to the details of at least one operation that are stored, presenting (i) information indicating which one of the one or more operation terminals has been used in operating the running and (ii) information indicating whether or not the details of at least one operation for the running have been performed using, among the one or more operation terminals, one operation terminal that is present in a same home as the electrical device.

General and specific aspects disclosed above may be implemented using a system, a method, an integrated circuit, a computer program, or a computer-readable recording medium such as a compact disc read only memory (CD-ROM), or any combination of systems, methods, integrated circuits, computer programs, or computer-readable recording media.

### Advantageous Effects of Invention

With a managing system according to the present invention, when a state of running of an electrical device is displayed, it is possible to determine (i) information indicating which one of operation terminals has been used in operating the running and (ii) whether or not details of the operation for the running have been carried out using, among one or more operation terminals, one operation terminal which is present in the same home as the electrical device.

### BRIEF DESCRIPTION OF DRAWINGS

FIG. 1 is a configuration diagram of a managing system as a whole according to Embodiment 1.

FIG. 2 is a block configuration diagram of the managing system according to Embodiment 1.

FIG. 3 is a diagram illustrating an operation flow of an operation performed using an operation terminal outside a home, in the managing system according to Embodiment 1.

FIG. 4 is a diagram illustrating an operation flow of an operation performed using an operation terminal in a home, in the managing system according to Embodiment 1.

FIG. 5 is a diagram illustrating an operation flow of an operation performed using a remote controller, in the managing system according to Embodiment 1.

FIG. 6 is a diagram illustrating an operation flow of requesting for operation history, performed using an operation terminal outside a home, in the managing system according to Embodiment 1.

FIG. 7 is a diagram illustrating a format of an operation signal according to Embodiment 1.

FIG. 8 (a) in FIG. 8 is a diagram illustrating an example of operation history stored in a server according to Embodiment 1, and (b) in FIG. 8 is a diagram illustrating an example of a terminal ID list stored in the server according to Embodiment 1.

FIG. 9 is a diagram illustrating history of operations and running of operations displayed on an operation terminal according to Embodiment 1.

FIG. 10 is another diagram illustrating history of operations and running of operations displayed on an operation terminal according to Embodiment 1.

FIG. 11 is a diagram illustrating an operation performed using an operation terminal according to Embodiment 1.

FIG. 12 is another diagram illustrating an operation performed using an operation terminal according to Embodiment 1.

FIG. 13 is a block configuration diagram of a managing system according to Embodiment 2.

FIG. 14 is a diagram illustrating an operation flow of an operation performed using an operation terminal outside a home, in the managing system according to Embodiment 2.

FIG. 15 is a diagram illustrating an operation flow of an operation performed using an operation terminal in a home, in the managing system according to Embodiment 2.

FIG. 16 is a diagram illustrating an operation flow of an operation performed using a remote controller, in the managing system according to Embodiment 2.

FIG. 17 is a diagram illustrating an operation flow of requesting for operation history, performed using an operation terminal outside a home, in the managing system according to Embodiment 2.

FIG. 18 is a diagram illustrating operation history displayed on an operation terminal according to Embodiment 2.

FIG. 19 is another diagram illustrating operation history displayed on an operation terminal according to Embodiment 2.

FIG. 20 is a diagram illustrating an overall operation flow of the managing system according to Embodiment 1.

FIG. 21 is another diagram illustrating an overall operation flow of the managing system according to Embodiment 1.

### DESCRIPTION OF EMBODIMENTS

In relation to the safety confirmation service disclosed in the Background Art section, the inventors have found the problem described below.

By the way, aside from the above-described safety confirmation service, a remote operation is known which, for example, turns on an electrical device such as an air conditioner, using a mobile phone or the like, from outside a home before arriving at the home, or turns off an air conditioner, using a mobile phone or the like, from outside a home after leaving the home. Since a registered mobile phone is capable of remotely operating an air conditioner both in and outside a home, it is possible for a user to perform a remote operation with no concern for being in or outside the home. The mobile phone capable of performing the remote operation is not limited to a mobile phone of a user, and the remote operation can be carried out using a mobile phone of another person (a family member of the user, for example) as long as the mobile phone is registered.

In addition, an electrical device such as an air conditioner has a function of a timer operation, and it is possible for a user to turn ON or OFF the air conditioner without performing a real-time operation, by previously setting a timer operation.

In the safety confirmation service, the following problems are posed when using operation history of an electrical device capable of performing a remote operation or a timer operation, as with the above-described air conditioner. (1) Since an electrical device can be operated both in and outside a home, it is difficult to determine whether a user has been in the home or outside the home when the electrical device was operated. (2) Since a remote operation can be performed using a plurality of mobile phones, it is difficult to determine, in the case where a remote operation has been performed, whether the remote operation has been carried out by a user or by another person. (3) Since a timer operation can be performed, it is difficult to determine, in the case where there has been a change in an operation state of an electrical device, whether a user has performed the operation in real time or a timer operation has been set previously. If the above-described determination can be carried out using the operation history, it is possible for a family member of a user to know the living situation of the user in more detail, thereby allowing a further increase in a quality of the safety confirmation service.

Here, although an air conditioner is given as an example, the present invention is applicable as well to any electrical devices capable of performing a remote operation or a timer operation.

In order to solve the above-described problem, a method of managing according to an aspect of the present invention is a method of managing an electrical device, including: storing details of at least one operation performed using any one of one or more operation terminals to operate an electrical device; and when a state of running of the electrical device is displayed according to the details of at least one operation that are stored, presenting (i) information indicating which one of the one or more operation terminals has been used in operating the running and (ii) information indicating whether or not the details of at least one operation for the running have been performed using, among the one or more operation terminals, one operation terminal that is present in a same home as the electrical device.

With this, when a state of running of an electrical device is displayed according to details of operations that are stored, it is possible to determine (i) information indicating which one of the one or more operation terminals has been used in operating the running and (ii) whether or not the details of at least one operation for the running have been performed using, among the one or more operation terminals, one operation terminal that is present in the same home as the electrical device.

For example, the information indicating whether or not the details of at least one operation for the running have been performed using, among the one or more operation terminals, one operation terminal that is present in a same home as the electrical device is determined according to which one of (i) an operation screen image for performing an operation in the same home as the electrical device and (ii) an operation screen image for performing an operation outside the home has been selected by a user to input the details of at least one operation, when the user has input the details of at least one operation for the running using the one of the one or more operation terminals.

With this, it is possible to determine whether or not the details of operations have been input using an operation terminal that is present in the same home as the electrical device, according to which one of (i) an operation screen image for performing an operation in the same home as the electrical device and (ii) an operation screen image for performing an operation outside the home has been selected by a user to input the details of operations when the user has input the details of operations using the operation terminal.

For example, the information indicating whether or not the details of at least one operation for the running have been performed using, among the one or more operation terminals, one operation terminal that is present in a same home as the electrical device is determined according to whether or not an operation signal for the running has been transmitted from the one of the one or more operation terminals to the electrical device via an outside-home communications line.

With this, it is possible to determine whether or not transmission has been carried out using an operation terminal that is present in the same home as the electrical device, according to whether or not an operation signal has been transmitted via an outside-home communications line when the operation signal has been transmitted from the operation terminal to an electrical device.

In addition, a method of managing an electrical device according to an aspect of the present invention is a method of managing an electrical device, including: storing details of at least one operation performed using any one of one or more operation terminals to operate an electrical device; and when running of the electrical device is displayed according to the details of at least one operation that are stored, presenting (i) information indicating which one of the one or more operation terminals has been used in operating the running and (ii) information indicating whether or not the running has been operated by a timer operation.

With this, it is possible to discriminate between an operation performed by a normal operation and an operation performed by a timer operation.

For example, the information indicating whether or not the running has been operated by a timer operation is determined according to which one of (i) an operation screen image for setting the timer operation and (ii) an operation screen image for a real-time operation has been selected by a user to input the details of at least one operation when the user has input the details of at least one operation for the running using the one of the one or more operation terminals.

With this, it is possible to determine whether or not the running has been operated by a timer operation according to which one of (i) an operation screen image for setting a timer operation and (ii) an operation screen image for a real-time operation has been selected by a user to input the details of an operation when the user has input the details of the operation using an operation terminal.

For example, the state of running of the electrical device is displayed in chronological order according to the details of at least one operation that are stored.

With this, it is possible to determine operation history in chronological order.

In addition, a managing system according to an aspect of the present invention is a managing system including: one or more electrical devices; one or more operation terminals for operating the one or more electrical devices by transmitting an operation signal; and a server for storing operation history from the one or more operation terminals, wherein when the one or more operation terminals communicate with the server and display the operation history, the one or more operation terminals display, together with information for identifying which one of the one or more operation terminals has issued an operation instruction to the one or more electrical devices, (i) distinctively the operation history from, among the one or more operation terminals, one operation terminal that is present in a same home as the one or more electrical devices, or (ii) only the operation history from the operation terminal that is present in the same home as the one or more electrical devices.

With this, when operation history of an electrical device is displayed, it is possible to determine (i) information indicating which one of operation terminals has been used in operating the running and (ii) whether or not the details of at least one operation for the running have been performed using, among the one or more operation terminals, one operation terminal that is present in the same home as the electrical device.

For example, whether or not an operation signal has been transmitted from the same home as the one or more electrical devices is determined according to whether or not the operation signal has been transmitted via the server when the one or more operation terminals have transmitted the operation signal to the one or more electrical devices.

With this, it is possible to determine whether or not an operation signal has been transmitted from an operation terminal to the electrical device using, among the one or more operation terminals, one operation terminal that is present in the same home as the electrical device, according to whether or not the operation signal has been transmitted via the server when the operation terminal has transmitted the operation signal to the electrical device.

In addition, a managing system according to an aspect of the present invention is a managing system including: one or more electrical devices; one or more operation terminals for operating the one or more electrical devices by transmitting an operation signal; and a server for storing operation history from the one or more operation terminals, wherein when the one or more operation terminals communicate with the server and display the operation history, the one or more operation terminals display distinctively operation history of a timer operation, together with information for identifying which one of the one or more operation terminals has issued an operation instruction to the one or more electrical devices.

With this, it is possible to discriminate between an operation performed by a normal operation and an operation performed by a timer operation.

In addition, an electrical device according to an aspect of the present invention is an electrical device which receives an operation signal from an operation terminal to control an operation, the electrical device discriminating between an operation signal received via a server and an operation signal received without involving the server, and transmitting, to the server, information of the operation signal received without involving the server, to add the information to history of the operation signal stored by the server.

With this, it is possible to store, in a server, operation history transmitted from an operation terminal to an electrical device without involving a server; that is history of an operation signal transmitted from a home.

In addition, an operation terminal according to an aspect of the present invention is an operation terminal for displaying operation history of one or more electrical devices, the operation terminal communicating with a server that stores the operation history from one or more operation terminals and information for identifying which one of the one or more operation terminals has issued an operation instruction, and when the operation history is displayed, displaying, together with the information for identifying which one of the one or more operation terminals has issued an operation instruction, (i) distinctively the operation history from, among the one or more operation terminals, one operation terminal that is present in a same home as the electrical device, or (ii) only the operation history from the operation terminal that is present in the same home as the electrical device.

With this, when a state of running of an electrical device is displayed according to the details of operations that are stored, it is possible to determine (i) information indicating which one of the one or more operation terminals has been used in operating the running and (ii) whether or not the details of operations for the running have been carried out using an operation terminal that is present in the same home as the electrical device.

In addition, a program according to an aspect of the present invention is a program for a managing system including: one or more electrical devices; one or more operation terminals for operating the one or more electrical devices by transmitting an operation signal; and a server for storing operation history from the one or more operation terminals, the program causing a computer to function as a managing system in which, when the one or more operation terminals communicate with the server and display the operation history, the one or more operation terminals display, together with information for identifying which one of the one or more operation terminals has issued an operation instruction to the one or more electrical devices, (i) distinctively the operation history from, among the one or more operation terminals, one operation terminal which is present in a same home as the electrical device, or (ii) only the operation history from the operation terminal which is present in the same home as the electrical device.

With this, when operation history of an electrical device is displayed, it is possible to determine (i) information indicating which one of the one or more operation terminals has been used in operating the running and (ii) whether or not the details of an operation for the running have been carried out using, among the one or more operation terminals, one operation terminal that is present in the same home as the electrical device.

These general and specific aspects may be implemented using a system, a method, an integrated circuit, a computer program, or a computer-readable recording medium such as a compact disc read only memory (CD-ROM), or any combination of systems, methods, integrated circuits, computer programs, or computer-readable recording media.

Hereinafter, certain exemplary embodiments are described with reference to the accompanying Drawings.

It is to be noted that the exemplary embodiments described below each show a general or specific example. The numerical values, shapes, materials, structural elements, the arrangement and connection of the structural elements, steps, the processing order of the steps, and so on, shown in the following exemplary embodiments are mere examples, and therefore do not limit the present invention. In addition, among the structural elements in the following exemplary embodiments, structural elements not recited in any one of the independent claims are described as arbitrary structural elements.

### Embodiment 1

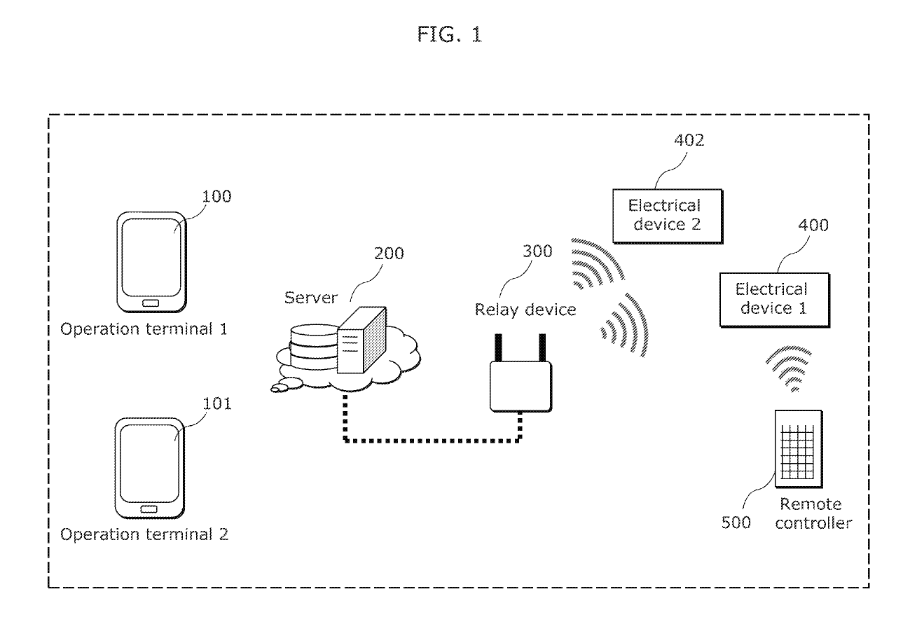

FIG. 1 illustrates a managing system according to an exemplary embodiment. The managing system includes: operation terminals 100 and 101; a server 200; a relay device 300; electrical devices 400 and 402; and a remote controller 500. The operation terminal 101 and the operation terminal 100 are the same in their configurations and operations, and thus detailed description will be omitted. The electrical device 402 and the electrical device 400 are the same in their configurations and operations, and thus detailed description will be omitted.

The operation terminal 100 is, for example, a personal computer (PC), a tablet PC, a mobile phone, smartphone, and the like. The operation terminal 100 is capable of acquiring (downloading) an application program from outside, and processes of the operation terminal 100 described below are executed by the application program.

The server 200 connected to the operation terminal 100 via a public line or a data communication network processes, stores, or transfers to the relay device 300, various signals transmitted from the operation terminal 100.

The relay device 300 is, for example, a home gateway or a base unit of a wireless LAN which is installed in a home of a user of the electrical device 400, relays to the electrical device 400 various signals transmitted from the server 200 via an optical line or the Internet line, and relays to the server 200 the various signals transmitted from the electrical device 400.

The electrical device 400 is an electrical device installed in a home of a user, and the examples of the electrical device include for example, an air conditioner, a television set, a recorder, an air handling unit, an air cleaner, a refrigerator, a washing machine, a rice cooker, a microwave oven, a hot water dispenser, a toilet seat warmer, a vacuum cleaner, and the like. In the following description, an air conditioner is given as an example of the electrical device.

A wireless communication between the relay device 300 and the electrical device 400 is implemented by a variety of communication tools (communication standard) such as a wireless LAN, Bluetooth (registered trademark), and a low-power radio. It is to be noted that, as another exemplary embodiment, the server 200 and the electrical device 400 may communicate without involving the relay device 300. In addition, the server 200 and the relay device 300 may be integrated and installed in a home of a user.

The remote controller 500 communicates with the electrical device 400 via an infrared communication or a wireless communication, to control the electrical device 400. The communication between the remote controller 500 and the electrical device 400 can be performed directly or via the relay device 300 in a home, and it is assumed here that the remote controller 500 and the electrical device 400 directly communicate with each other. It is to be noted that, when the remote controller 500 communicates with the electrical device 400 via the relay device 300 in the home, the communication is carried out in the same manner as the case where the electrical device 400 is operated with the operation terminal 100 being placed in the home, and thus detailed explanations will not particularly be provided in the following description.

In FIG. 1, the server 200 decodes a control signal transmitted from the operation terminal 100, and identifies a communications line to which the electrical device 400 is connected. The communications line is determined by a broadband router which communicates with the server 200 via a line outside the home typified by the Internet (ADSL, optical cable, for example) and a gateway connected to the broadband router via a line in the home typified by a home LAN.

In FIG. 1, a control signal transmitted from the operation terminal 100 can be transmitted from the server 200 to the gateway via the broadband router when the broadband router is managed by a fixed network address (fixed IP address, for example).

In the case where the broadband router is managed by a variable network address such as DHCP (dynamic host configuration protocol), the gateway acquires a control signal transmitted from the operation terminal 100, via the broadband router and the server 200. It is assumed here that the server 200 is managed by a fixed network address.

The relay device 300 according to this exemplary embodiment includes the above-described broadband router or gateway.

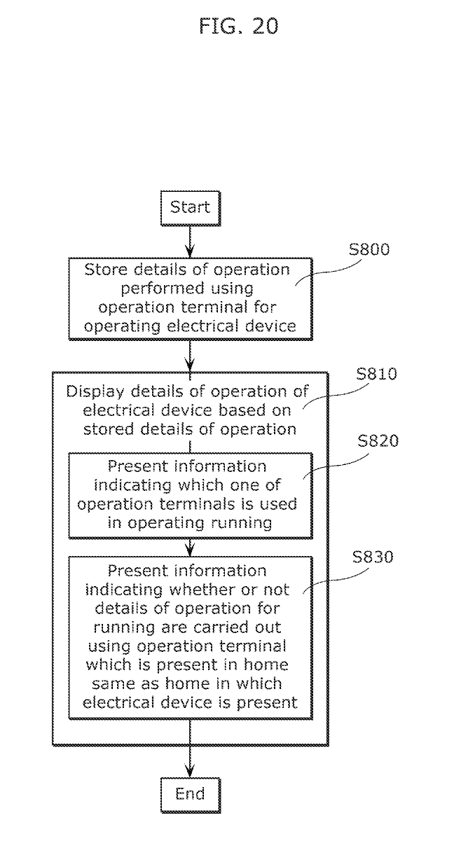

FIG. 20 is a diagram illustrating an overall operation flow of Embodiment 1. In a managing system according to Embodiment 1, details of at least one operation performed using any one of the operation terminals 100 and 101 to operate one or more electrical devices 400 and 402 are stored (Step S800); and when a state of running of the electrical device is displayed according to the details of at least one operation that are stored (S810), (i) information indicating which one of the one or more operation terminals has been used in operating the running is presented (Step S820) and (ii) information indicating whether or not the details of at least one operation for the running have been performed using, among the one or more operation terminals, one operation terminal that is present in a same home as the electrical device is presented (Step S830).

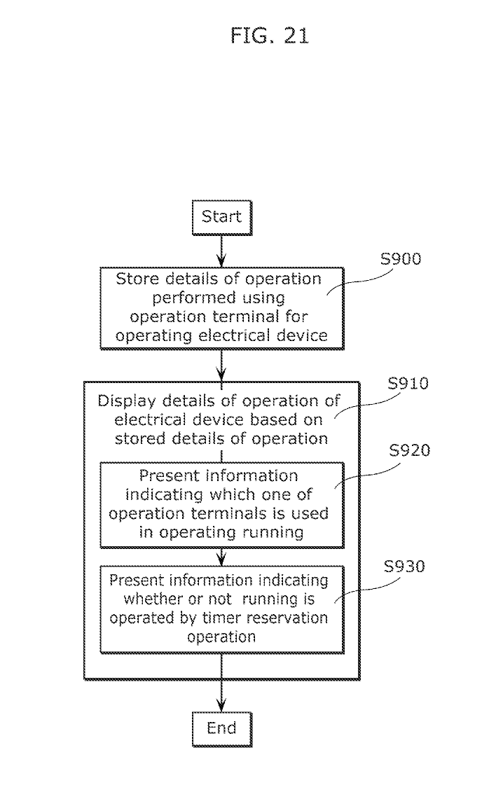

In addition, FIG. 21 is another diagram illustrating an overall operation flow according to Embodiment 1. In a managing system according to Embodiment 1, details of at least one operation performed using any one of the operation terminals 100 and 101 to operate one or more of the electrical devices 400 and 402 are stored (Step S900); and when running of the electrical device is displayed according to the details of at least one operation that are stored (Step S910), (i) information indicating which one of the one or more operation terminals has been used in operating the running is presented (Step S920), and (ii) information indicating whether or not the running has been operated by a timer operation is presented (Step S930).

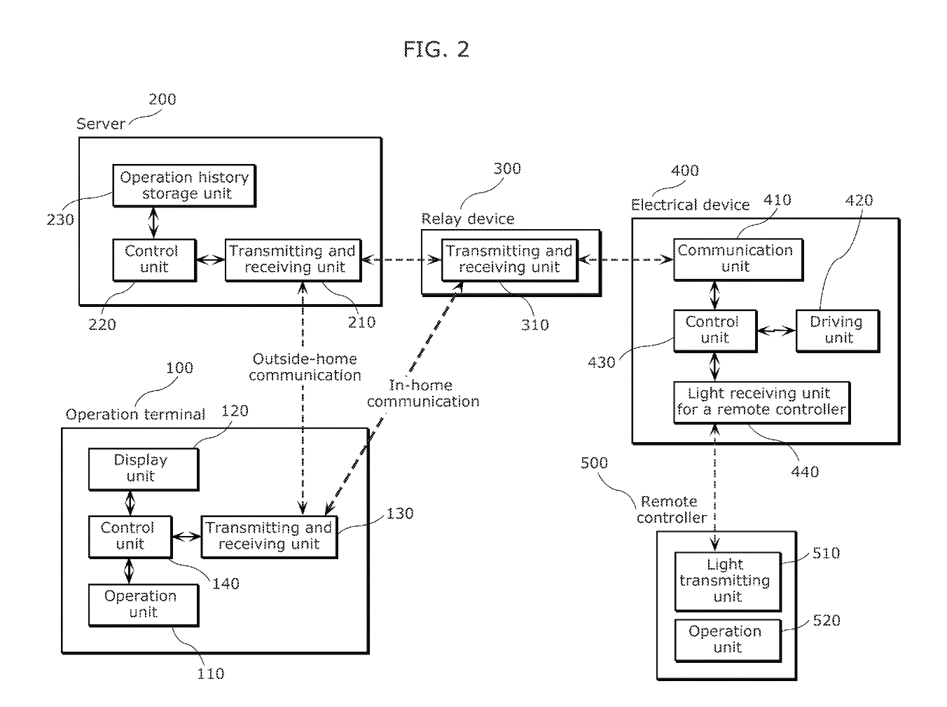

FIG. 2 illustrates block configuration diagrams of the operation terminal 100, the server 200, the relay device 300, the electrical device 400, and the remote controller 500.

The operation terminal 100 includes: an operation unit 110; a display unit 120, a transmitting and receiving unit 130; and a control unit 140.

The transmitting and receiving unit 130 transmits, to the server 200 or the relay device 300, details of an operation performed by a user of the electrical device 400 using the operation unit 11. In addition, the transmitting and receiving unit 130 notifies the user of the details received from the server 200 or the relay device 300, by displaying the details on the display unit 120.

The operation unit 110 includes an operation button that is physically provided on the operation terminal 100 or an operation button provided on a touch panel.

The display unit 120 is a display that displays various information items related to the functions of the operation terminal 100. In addition, the display unit may be configured to have the functions of an LED display or audible alert.

In recent years, a touch panel having the combination of functions of the operation unit 110 and the display unit 120 has come into widespread use, and thus the operation unit 110 may be implemented by the operation button displayed on the display unit 120.

The transmitting and receiving unit 130 is a means for communicating with the server 200 or the relay device 300, and performs transmission or receiving by a wireless public line, a data communication network, a wireless LAN, or the like.

In other words, in a home where the electrical device 400 or the relay device 300 is installed, the operation terminal 100 communicates with the relay device 300 via the wireless LAN, Bluetooth (registered trademark), a low-power radio, or the like. In addition, since the operation terminal 100 is in a communication area in which direct communication with the relay device 300 is impossible when the operation terminal 100 is outside a home, the operation terminal 100 uses a wireless public line or a data communication network which allows communication anywhere to communicate with the server 200, and communicates with the relay device 300 via the server 200. It is to be noted that various methods are present for the steps to authenticate and allow communications between the operation terminal 100 and the relay device 300, and thus descriptions will be omitted here.

The operation terminal 100 is of course capable of communicating with the server 200 in a home as well using the wireless public line or the data communication network. However, the operation terminal 100 preferentially selects a path to directly communicate with the relay device 300 when the operation terminal 100 is capable of directly communicating with the relay device 300 using the wireless LAN or the like. In this way, it is possible to reduce communication time and there is an advantage that no costs are involved for the communication.

The control unit 140 of the operation terminal 100 controls: the operation unit 110; the display unit 120; and the transmitting and receiving unit 130. The control unit 140 selects whether the transmitting and receiving unit 130 communicates with the relay device 300 or the transmitting and receiving unit 130 communicates with the server 200, according to the communication state of the transmitting and receiving unit 130; that is, whether or not a radio wave is received from the relay device 300, or whether or not a direct communication with the relay device 300 is possible, for example.

The server 200 includes: a transmitting and receiving unit 210; a control unit 220; and an operation history storage unit 230. The server 200 relays a communication between the operation terminal 100 and the relay device 300 to establish a communication when the operation terminal is present outside a home. In addition, the server 200 stores the details of operating the electrical devices 402 and 402 using the operation terminal 100, as the operation history. The operation history storage unit 230 may store history of running of operations of the electrical devices 400 and 402 in addition to the operation history.

The transmitting and receiving unit 210 communicates with the operation terminal 100 or the relay device 300 using the public line or the data communication network.

It is to be noted that, in this exemplary embodiment, the transmitting and receiving unit 210 may arbitrarily include a transmitting unit and a receiving unit separately, or include a transmitting and receiving unit which communicates with the operation terminal 100 and a transmitting and receiving unit which communicates with the relay device 300 separately.

The operation history storage unit 230 acquires and stores operation history of the electrical devices 400 and 402 with a method described later.

The control unit 220 controls transmitting and receiving unit 210 and the operation history storage unit 230.

The server 200 executes other various functions for relaying a communication between the operation terminal 100 and the electrical device 400. However, the descriptions for them will be omitted in the exemplary embodiment.

The relay device 300 relays a communication between the server 200 and the electrical device 400 to establish a communication when the operation terminal 100 is present outside a home. In addition, the relay device 300 relays a communication between the operation terminal 100 and the electrical device 400 to establish a communication when the operation terminal 100 is present outside a home.

The transmitting and receiving unit 310 receives various signals transmitted from the server 200, and relays the received signals to the electrical device 400. The relay device 300 and the server 200 may be connected via a wired communication (an optical line or the like), or may be connected via a wireless communication (a data communication network or the like).

In addition, the transmitting and receiving unit 310 receives various signals transmitted from the operation terminal 100 that is present in a home, and relays the received signals to the electrical device 400. The relay device 300 and the operation terminal 100 are connected via a wireless communication (a wireless LAN, Bluetooth (registered trademark), a low-power radio, etc.), or the like.

The relay device 300 and the electrical device 400 may be connected via a wired communication (wired LAN, or the like), or may be connected via a wireless communication (a wireless LAN, Bluetooth (registered trademark), a low-power radio, etc.).

It is to be noted that the transmitting and receiving unit of the relay device 300 may arbitrarily include a transmitting and receiving unit which communicates with the server 200, a transmitting and receiving unit which communicates with the operation terminal 100, and a transmitting and receiving unit which communicates with the electrical device 400, separately.

The relay device 300 executes other various functions for relaying a communication. However, the descriptions for them will be omitted in the exemplary embodiment.

The electrical device 400 includes: a communication unit 410; a driving unit 420; a control unit 430; and a light receiving unit 440 which receives a signal from a remote controller.

The communication unit 410 is a means for communicating with the relay device 300, and performs transmitting and receiving using a wireless LAN, Bluetooth (registered trademark), a low-power radio, or the like.

The communication unit 410 may be integrally built into the electrical device 400, or may be configured to be attached later to the electrical device 400 as an adapter type.

The driving unit 420 is a means for converting power that is an engine of the electrical device 400 into a motion. For example, when the electrical device 400 is a washing machine, the driving unit 420 corresponds to a motor which causes a washing tub to rotate. In addition, when the electrical device 400 is an air handling unit, the driving unit 420 corresponds to a compressor. In addition, a thermal converter or the like may be included instead of the drive unit, and the configuration of the driving unit 420 is not particularly specified according to the exemplary embodiment.

The light receiving unit for a remote controller 440 receives an operation signal from the remote controller 500. Not only an infrared communication but also a wireless communication may be used. In addition, the light receiving unit for a remote controller 440 may perform not only a unidirectional communication for receiving an operation signal from the remote controller 500 but also a bidirectional communication for also transmitting an operation running state or a setting state of the electrical device 400 from the light receiving unit for a remote controller 440 to the remote controller 500.

The control unit 430 controls: the communication unit 410; the driving unit 420; and the light receiving unit for a remote controller 440.

The remote controller 500 includes a light transmitting unit 510 which transmits an operation signal to the electrical device 400 and an operation unit 520.

The remote controller 500 transmits details of an operation performed by the user using the operation unit 520 from the light transmitting unit 510 to the electrical device 400.

It is to be noted that the configuration is not limited to that in FIG. 2, and the server 200 and the electrical device 400 may directly communicate with each other without involving the relay device 300, by providing the communication unit 410 of the electrical device 400 with a communication function of an outside-home communication (a public line, a data communication network, an optical line, or the Internet). In addition, the operation terminal 100 and the electrical device 400 may directly communicate with each other without involving the relay device 300. The server 200 and the relay device 300 may be integrated and installed in a home of a user.

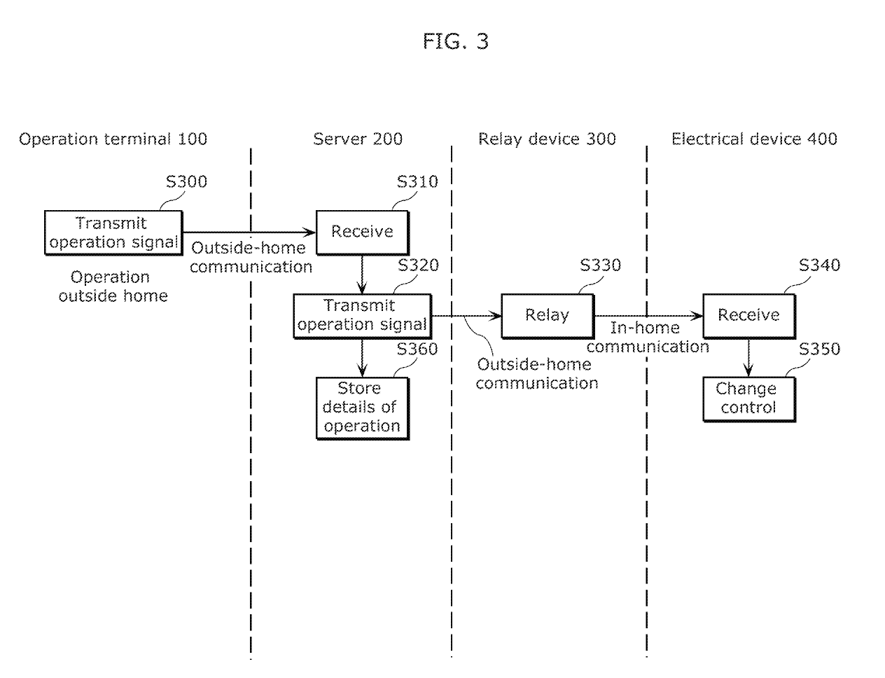

FIG. 3 is a sequence diagram explaining an operation for transmitting an operation signal from the operation terminal 100 outside a home and performing a remote control on the electrical device 400 in response to the operation signal.

Here, the relay device 300 determines that an in-home operation has been performed when an operation signal transmitted from the transmitting and receiving unit 130 of the operation terminal 100 is directly delivered to (or can be received by) the transmitting and receiving unit 310 of the relay device 300, and that an outside-home operation has been performed when the operation signal is not directly delivered or is delivered via the server 200. In addition, when the signal transmitted from the transmitting and receiving unit 310 of the relay device 300 is directly delivered to (or can be received by) the transmitting and receiving unit 130 of the operation terminal 100, the operation terminal 100 transmits the signal to the relay device 300 using the in-home communication (a wireless LAN, Bluetooth (registered trademark), a low-power radio, or the like), and transmits the signal to the server 200 using the outside-home communication (a public line or a data communication network) when the signal is not directly delivered. It is to be noted that various methods are present for the steps to authenticate and allow each of: a communication between the operation terminal 100 and the server 200; a communication between the operation terminal 100 and the relay device 300; and a communication between the relay device 300 and the server 200, and thus descriptions will be omitted here.

In addition, when an IP address is used, the relay device 300 is capable of identifying whether or not the operation terminal 100 which has transmitted an operation signal is present in the same sub network as the relay device 300. When the operation terminal 100 which has transmitted an operation signal is present in the same sub network as the relay device 300, the relay device 300 determines that the operation signal has been transmitted by an in-home operation. On the other hand, when the operation terminal 100 which has transmitted an operation signal is present in a sub network different from a sub network of the relay device 300, the relay device 300 determines that the operation signal has been transmitted by an outside-home operation. In addition, the operation terminal 100 is capable of identifying, using an IP address, whether or not the relay device 300 is present in the same sub network as the operation terminal 100. The operation terminal 100 transmits the operation signal to the relay device 300 using an in-home communication (a wireless LAN, Bluetooth (registered trademark), a low-power radio, or the like) when the relay device 300 is present in the same sub network as the operation terminal 100. The operation terminal 100 transmits the operation signal to the server 200 using the outside-home communication (a public line or a data communication network) when the relay device 300 is not in the same sub network as the operation terminal 100.

First, a user of the operation terminal 100 inputs operation details information of the electrical device 400 using the operation unit 110, the control unit 140 generates an operation signal including the operation details information in Step S300, determines whether to perform an in-home communication or an outside-home communication according to a receiving state or an IP address, and transmits the operation signal from the transmitting and receiving unit 130 to the server 200 using the outside-home communication in FIG. 3.

The server 200 receives an operation signal by the transmitting and receiving unit 210 in Step S310, and transmits the operation signal to the relay device 300 in Step S320, and then the relay device 300 transmits the operation signal to the electrical device 400 in Step S330.

The communication unit 410 of the electrical device 400 receives the operation signal transmitted from the relay device 300 in Step S340, and the control unit 430 controls an operation of the driving unit 420 according to the operation details information included in the operation signal in Step S350.

The server 200, in Step S360, stores the operation signal transmitted to the electrical device 400 in the operation history storage unit 230 to generate operation history.

In addition, although it is not illustrated, in one conceivable embodiment, after the server 200 transmits an operation signal to the electrical device 400 via the relay device 300 (Step S230), the electrical device 400 transmits a response signal (in the same format as the operation signal) that indicates that the operation signal has been received by the electrical device 400 and executed (Step S340 and Step S350), to the server 200 via the relay device 300. In this case, the server 200 may store the operation details by receiving the response signal. According to this embodiment, it is possible to generate memory of operation history by the server 200 using the operation history of the electrical device 400 included in the response signal.

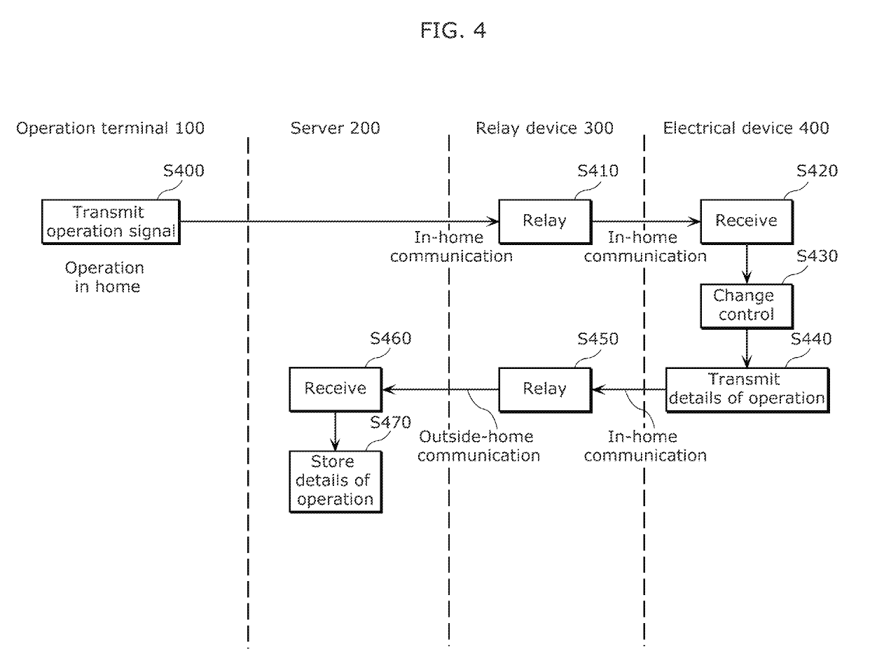

FIG. 4 is a sequence diagram explaining an operation for transmitting an operation signal from the operation terminal 100 in a home and performing a remote control on the electrical device 400 in response to the operation signal.

The difference from FIG. 3 is that the operation terminal 100 and the relay device 300 directly communicate with each other without involving the server 200 because the communications are performed in a home. One example case is that the operation terminal 100 is present in the same sub network (for example, an in-home wireless LAN or a low-power communication network) as the relay device 300.

First, a user of the operation terminal 100 inputs operation details information of the electrical device 400 using the operation unit 110, the control unit 140 generates an operation signal including the operation details information in Step S400, determines whether to perform an in-home communication or an outside-home communication according to a receiving state or an IP address, and transmits the operation signal to the relay device 300 via the transmitting and receiving unit 130 using the in-home communication in FIG. 4.

The relay device 300 receives the operation signal by the transmitting and receiving unit 310 in Step S410, and transmits the operation signal to the electrical device 400 in Step S410.

The communication unit 410 of the electrical device 400 receives the operation signal transmitted from the relay device 300 in Step S420, and the control unit 430 controls an operation of the driving unit 420 according to the operation details information included in the operation signal in Step S430.

Then, in order to generate operation history in the operation history storage unit 230 of the server 200, the control unit 430 of the electrical device 400 transmits the operation signal received from the relay device 300, to the relay device 300 from the communication unit 410 in Step S440. The relay device 300 receives the operation signal by the transmitting and receiving unit 310, and transmits the operation signal to the server 200 in Step S450. In the case where the control of an operation according to the operation details information included in the operation signal in a control change in Step S430 cannot be carried out, the operation signal is transmitted from the communication unit 410 to the relay device 300 with information indicating the result in Step S440, and the operation signal is transmitted to the server 200 in Step S450.

The server 200 receives, by the transmitting and receiving unit 210, the operation signal transmitted from the relay device 300 in Step S460, and stores the operation signal into the operation history storage unit 230 to generate operation history in Step S470.

Here, when transmitting an operation signal from outside a home using the operation terminal 100 as illustrated in FIG. 3, the operation signal is stored when the operation signal passes through the server 200 (Step S360), and thus it is not required to transmit the operation details from the electrical device 400 as described above. In addition, in one conceivable embodiment, after the electrical device 400 receives the operation signal (Step S420), a response signal indicating that the operation signal is received and executed by the electrical device 400 (Step S430) is transmitted to the server 200 from the electrical device 400 via the relay device 300. In this case, the server 200 may store the operation details by receiving the response signal. More specifically, in the above-described Step S440, a response signal is transmitted instead of transmitting the operation details, and the server 200 generates memory of operation history using the operation history of the electrical device 400.

As described above, in an electrical device which receives an operation signal from the operation terminal to control an operation, an operation signal received via the server and an operation signal received without involving the server are discriminated, and information of the operation signal received without involving the server is transmitted to the server, thereby making it possible to add the information to the history of the operation signal stored in the operation history storage unit 230.

With the configuration as described above, it is possible to store, in the server, history of an operation transmitted from the operation terminal to the electrical device without involving the server; that is, history of an operation signal transmitted from a home.

Although the control unit 430 of the electrical device 400 transmits the received operation signal to the server 200 in FIG. 4 as described above, it is also conceivable that the transmitting and receiving unit 310 of the relay device 300 performs the above operations. More specifically, the relay device 300 transmits, to the server 200, an operation signal received by directly communicating with the operation terminal 100, and causes the operation history storage unit 230 to generate operation history. In addition, even when an operation signal is transmitted from the operation terminal 100 in a home, in one conceivable embodiment is that the operation terminal 100 transmits the operation signal to the server 200 as in FIG. 3, and the server 200 transmits the operation signal to the electrical device 400 via the relay device 300, using an outside-home communication (a public line or a data communication network).

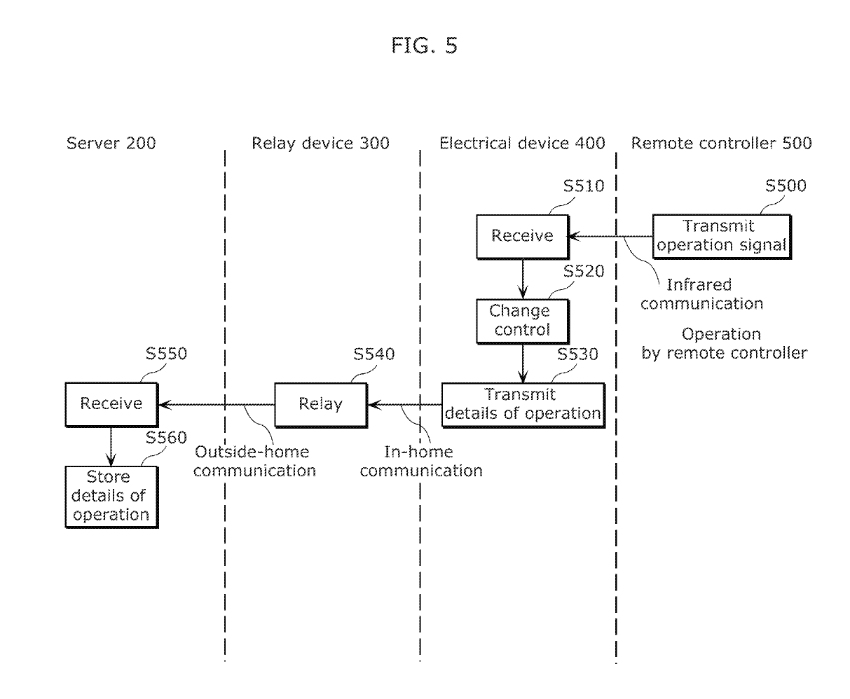

FIG. 5 is a sequence diagram explaining an operation for transmitting an operation signal from the remote controller 500 and performing a remote control on the electrical device 400 in response to the operation signal.

The difference from FIG. 3 and FIG. 4 is that the remote controller 500 and the electrical device 400 directly communicate with each other without involving the server 200 or the relay device 300.

First, a user of the remote controller 500 inputs operation details information of the electrical device 400 using the operation unit 520, generates an operation signal including the operation details information in Step S500, and transmits the generated operation signal to the from the light transmitting unit 510 to the electrical device 400.

The light receiving unit for a remote controller 440 of the electrical device 400 receives the operation signal transmitted from the remote controller 500 in Step S510, and the control unit 430 controls an operation of the driving unit 420 according to the operation details information included in the operation signal in Step S520.

Then, the control unit 430 of the electrical device 400 causes the communication unit 410 to transmit to the relay device 300 the operation signal received from the remote controller 500, in order to generate, in the server 200, operation history of the operation signal transmitted from the remote controller 500. The relay device 300 receives the operation signal by the transmitting and receiving unit 310, and transmits the operation signal to the server 200 in Step S540 in the same manner as Step S450.

The server 200 receives, by the transmitting and receiving unit 210, the operation signal transmitted from the relay device 300 in Step S550, and stores the operation signal into the operation history storage unit 230 to generate operation history in Step S560 in the same manner as Step S470 illustrated in FIG. 4. In addition, in one conceivable embodiment, after the remote controller 500 transmits the operation signal to the electrical device 400 (Step S500), a response signal indicating that the operation signal is received and executed by the electrical device 400 (Step S520) is transmitted to the server 200 from the electrical device 400 via the relay device 300. In this case, the server 200 may store the operation details by receiving the response signal. More specifically, a response signal is transmitted instead of transmitting the operation details in the above-described Step S530, and the server 200 generates memory of operation history using the operation history of the electrical device 400 included in the response signal in Step S560.

With this, it is possible to generate operation history by storing history of the operation signal into the server, for the operation details transmitted from the remote controller to the electrical device as well.

As described above, in an electrical device which receives an operation signal from an operation terminal (including a remote controller) to control an operation, an operation signal received via the server and an operation signal received without involving the server are discriminated, and information of the operation signal received without involving the server is transmitted to the server, thereby making it possible to add the information to the history of the operation signal stored in the server.

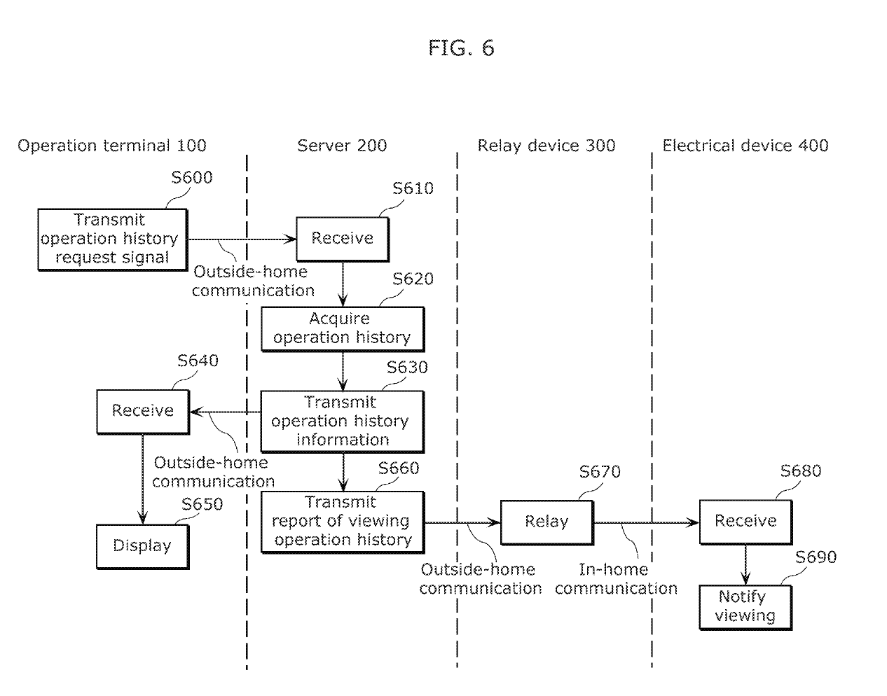

Next, a sequence when viewing, on the operation terminal 100, the operation history generated in the operation history storage unit 230 of the server 200 as described above will be explained with reference to FIG. 6. When performing the safety confirmation service for a user of the electrical device 400, it is assumed that a person who hopes to view operation history is not the user himself or herself of the electrical device 400 but a family member of the user who lives in a different home. It is assumed that there are a plurality of the operation terminals 100 and each of the user and the family member owns an operation terminal.

In the exemplary embodiment, it is assumed that a user himself or herself is also allowed to view the operation history of the user, in addition to a family member of the user.

First, a user of the electrical device 400 or a family member of the user inputs a request for operation history of the electrical device 400 using the operation unit 110 of the operation terminal 100 which they each own, and the control unit 140 generates a operation history request signal including the request for operation history, and transmits the generated operation history request signal to the server 200 via the transmitting and receiving unit 130 in Step S600.

The control unit 220 of the server 200 receives, by the transmitting and receiving unit 210, the operation history request signal in Step S610, acquires the operation history information from the operation history storage unit 230 in Step S620. It is to be noted that various methods are present for the steps to authenticate a requester for operation history as a user or a family member of the user and allow the requester to view the operation history, and thus descriptions will be omitted here.

In Step S630, the operation history information is transmitted to the operation terminal 100.

The transmitting and receiving unit 130 receives the operation history information from the server 200 in Step S640, and the display unit 120 displays the operation history information in Step S650.

Subsequently, the server 200 transmits a report that the operation history information has been transmitted to the operation terminal 100; that is, there has been a request for viewing the operation history (Step S660). When it is found, as a result of authenticating the requester for the operation history, that the requester is other than the user, the transmitted report of viewing the operation history is received by the electrical device 400 via the relay device 300 (Step S680). Upon receiving the report, the electrical device 400 notifies to the user that there has been a request for viewing the operation history (Step S690).

With this, it is possible to notify to the user of the electrical device 400 that someone other than the user of the electrical device 400 has acquired or viewed the operation history by operating the operation terminal. In other words, it is possible to notify the user that the operation history has been checked, and in terms of the safety confirmation service, it is possible to provide the user with a sense of being watched out for his or her safety by a family member living in a different home.

When there has been a report of viewing the operation history, for example, an LED provided in a main body of the electrical device 400 is blinked, or an audio notice such as “there was a safeguard watch.” is provided. Alternatively, although it is not illustrated, a report of viewing the operation history may be transferred from the electrical device 400 or the relay device 300 to the operation terminal owned by the user of the remote controller 500 or the electrical device 400 to blink the LED provided on the operation terminal or display a notice “there was a safeguard watch” on a display unit.

At this time, as described later, the server 200 may determine who owns the operation terminal from which the request for the operation history has been issued, add information of a requester for viewing to information of the report of viewing the operation history, and notify a user of who has issued the request for the operation history by providing a notice, for example, “there was a safeguard watch from B”.

It is to be noted that FIG. 6 is a sequence diagram for the case where the operation terminal 100 is outside a home. When the operation terminal 100 in a home, the operation terminal 100 transmit or receive a request for operation history and operation history information by connecting to the server 200 via the relay device 300.

It is to be noted that, although the relay device 300 is illustrated in FIG. 3, FIG. 4, FIG. 5, and FIG. 6, a configuration which does not use a relay device is also conceivable. For example, the communication unit 410 of the electrical device 400 may be provided with a communication function of the outside-home communication (a public line, a data communication network, an optical line, and the Internet) to allow the server 200 and the electrical device 400 to directly communicate with each other without using the relay device 300, or to allow the operation terminal 100 and the electrical device 400 to directly communicate with each other without using the relay device 300.

In addition, instead of the operation terminal 100, a display terminal (not illustrated) which does not emit an operation signal of the electrical device 400 may be used for viewing the operation history generated in the server 200. For the display terminal, an operation terminal of another electrical device, a personal computer, a smartphone, or a mobile terminal is conceivable.

In addition, although it is not illustrated, operation history information may be acquired from the server 200 and displayed, using the remote controller 500 instead of an operation terminal. This can be done by transmitting a request for viewing of operation history to the server 200 via the electrical device 400 and the relay device 300, and receiving the operation history information from the server 200, using the remote controller 500. At this time, the remote controller 500 performs a bidirectional communication.

By the way, it is also conceivable that the operation history storage unit 230 is provided to the relay device 300 or the electrical device 400, instead of providing the operation history storage unit 230 to the server 200. As to which one of the server 200, the relay device 300, the electrical device 400, and the operation terminal owned by a user is provided with the storage unit for storing operation history in implementing the exemplary embodiment, there are various conceivable forms because the exemplary embodiment can be implemented by transmitting the operation history to the device including the storage unit to cause the device to store the operation history, and by transmitting a request for viewing the operation history to the device including the storage unit to acquire the operation history.

In the exemplary embodiment, the server 200 includes the operation history storage unit 230 in consideration of the fact that it is possible to ensure the capacity necessary for generating memory of the operation history. In addition, the operation history storage unit may be included in a server different form the server 200 that communicates with the operation terminal 100 to increase security for the operation history. Alternatively, it is also conceivable to include the operation history storage unit in the relay device 300 in a home. In this case, when the relay device 300 relays an operation signal in S330 of FIG. 3, and when the relay device 300 receives an operation signal in S450 of FIG. 4 and S540 of FIG. 5, the operation details is stored in the operation history storage unit included in the relay device 300. In this case, transmission from the relay device 300 to the server 200, as in S460 and S550, is not required.

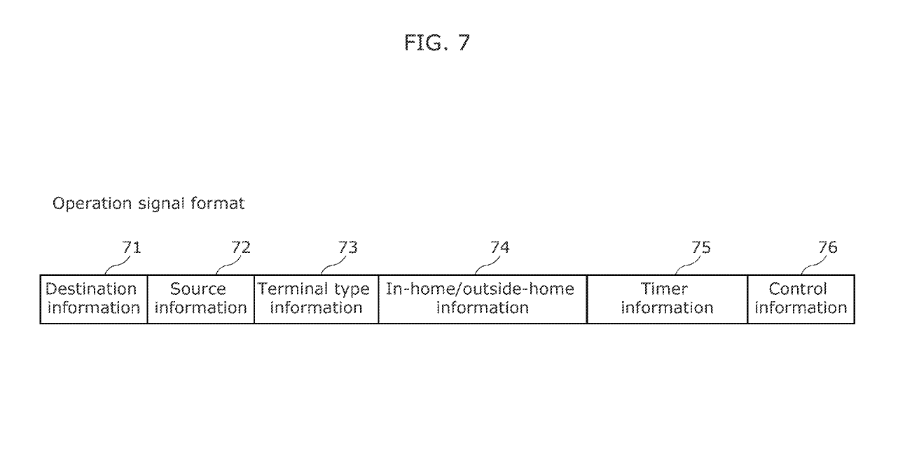

Here, a format of an operation signal is explained with reference to FIG. 7.

An operation signal includes at least the following information items.

(1) Destination information 71: indicating an ID of a device which is the destination of the operation signal When operating the electrical device 400 from the operation terminal 100, the destination information 71 indicates an ID of the electrical device 400.

(2) Source information 72: indicating an ID of a device which has transmitted the operation signal When operating the electrical device 400 from the operation terminal 100, the source information 72 indicates an ID of the operation terminal 100.

(3) Terminal type information 73: indicating a type of the terminal device which is the source of transmission For example, the terminal type information 73 indicates the remote controller 500 when the terminal type information indicates “0”, and the terminal type information 73 indicates the operation terminal 100 when the terminal type information indicates “1”.

(4) in-home/outside-home information 74: indicating whether the operation terminal 100 that is the source of transmission is in the same home as the terminal device (electrical device 400) that is the destination of transmission or is outside the home. For example, it is indicated that the operation signal is transmitted: from the same home when the in-home/outside-home information indicates “2”; from outside the home when the in-home/outside-home information indicates “3”; and from the remote controller when the in-home/outside-home information indicates “0”. How the operation terminal 100 determines in-home or outside-home will be described later. It is to be noted that, the remote controller performs transmission from the same home as the electrical device 400 when an infrared communication is used, and thus the information may indicate “2”, however, the information indicates “0” here in order to discriminate between the operation terminal 100 and the remote controller 500.

(5) Timer information 75: indicating whether or not the operation details are performed by a timer operation For example, it is indicated that the operation is performed by a timer operation when the timer operation information indicates “1”, and that the operation is not performed by a timer operation (a real-time operation) when the timer operation information indicates “0”.

(6) Control information 76: indicating details of control performed on a destination device (electrical device 400) When the electrical device is an air conditioner, the control information includes, on or off of running, refrigerated air conditioning, air heating, dehumidification, temperature setting, air volume setting, and wind direction setting, an the like. In addition when (5) the timer information 75 indicates that the timer operation is on, the control information 76 also includes a time setting for on or off of the timer operation.

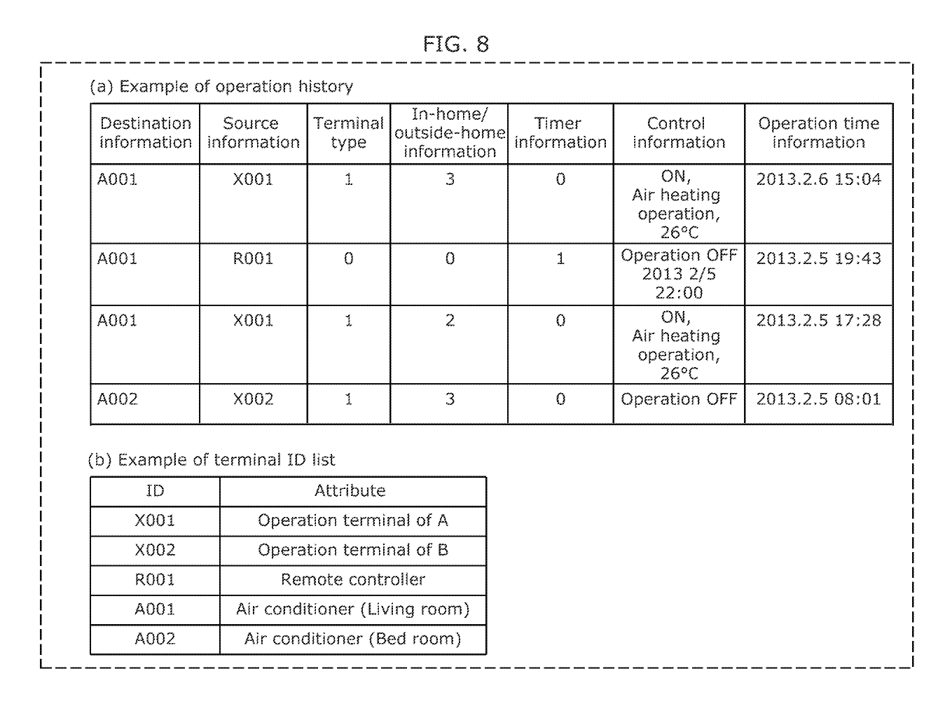

Next, information of the operation history generated and stored by the server 200 will be explained with reference to FIG. 8.

In FIG. 8, (a) illustrates is an example of operation history.

The control unit 220 of the server 200 receives an operation signal and stores the operation signal in the operation history storage unit 230. The operation history is based on an operation signal format illustrated in FIG. 7, and for example, items of the operation history in the top row illustrated in (a) of FIG. 8 indicates the following details.

(1) Destination information: a device “A001”

(2) Source information: a device “X001”

(3) Terminal type: indicating “1” and thus an operation terminal

(4) in-home/outside-home information: indicating “3” and thus transmission is performed from outside a home

(5) Timer information: indicating “0” and thus the operation is not performed by a timer operation (performed by a real-time operation)

(6) Control information: an air heating operation is on.

Temperature is set at 26 degrees.

(7) Operation time information: Feb. 6, 2013, 15:04

It is to be noted that, for (7) operation time, a time at which operation is performed using the operation terminal or a time at which transmission is performed from the operation terminal is provided. Alternatively, a time at which an operation signal is received by the electrical device 400 or a time at which an operation signal is received by the server 200 may be provided. In addition, a combination of a plurality of the times described above may be stored as operation history.

In addition, the server 200 includes a terminal ID list such as (b) in FIG. 8. The terminal ID list is created by preliminarily registering an ID and an attribute of each terminal device of a managing system to which the server belongs.

For example, (1) destination information “A001” in the above-described operation history illustrated in (a) of FIG. 8 indicates an air conditioner that is installed in a living room, and (2) source information “X001” indicates an operation terminal owned by A (for example, a smartphone or a mobile phone).

Accordingly, the operation history in the top row illustrated in (a) of FIG. 8 indicates that air heating operation of the air conditioner that is placed at the living room was turned on the with a temperature setting at 26 degrees, from outside a home using an operation terminal owned by A, at 15:04 on Feb. 6, 2013.

It is to be noted that, although four past operation history items are illustrated in (a) of FIG. 8, the server stores operation history items as may as the storage capacity of the operation history storage unit permits.

Then, as described in FIG. 6, it is possible to view the operation history of (a) in FIG. 8 by requesting from the operation terminal 100. The following describes some of display examples. It is possible for a family member living in a different home to know a living situation of a user by viewing the operation history (safety confirmation service).

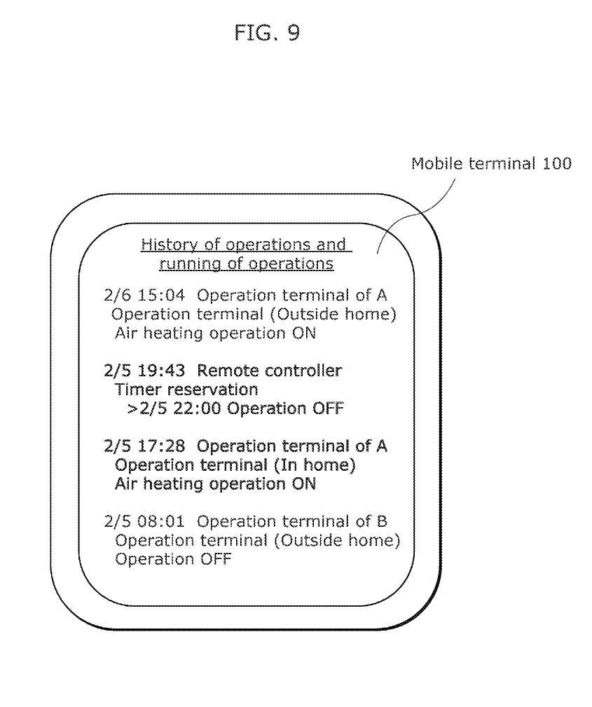

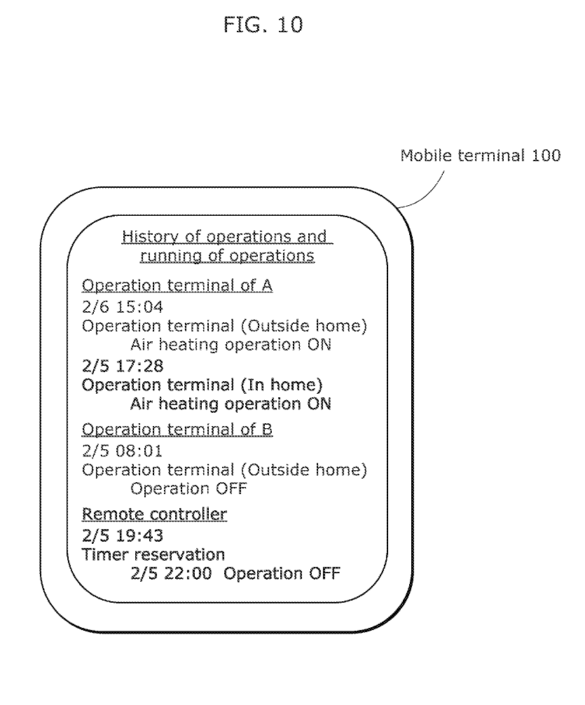

FIG. 9 illustrates history of operations and running of operations of the past displayed on the operation terminal 100 in a list format. In addition, FIG. 10 illustrates history of operations and running of operations sorted for each operation terminal (for each person having an operation terminal) in the list format and displayed on the operation terminal 100.

In the history of operations and running of operations, items are displayed in chronological order according to the operation times, and items for a predetermined period counting backward from the present time (for the past three days in FIG. 9) are displayed.

Since an item of the operation history performed from the operation terminal which is present in a home is distinctively displayed by, for example, highlighting with italics, bold, or colored characters, it is possible for a viewer to easily understand that user A of the electrical device was at home at the time.

In addition, since an item of the timer operation is distinctively displayed by, for example, highlighting with italics, bold, or colored characters by a different color, it is possible for a viewer to understand that the electrical device 400 was not actually operated by A at the time when the electrical device 400 was turned on or off, but a timer was set previously at a different time.

In addition, when there is an item of operation history performed by the operation terminal owned by A from outside a home, it is possible for the viewer to understand that A was outside the home at the time.

It is to be noted that operation history performed by the operation terminal which is present outside a home may be excluded from display of operation history, and only an operation performed by an operation terminal or a remote controller which is present in the home may be displayed, thereby making it possible to know a time when someone was in the home. In addition, only the operation history related to a specific operation terminal (a user who owns it) may be displayed, thereby making it possible to know a time when user A was in a home and a time when user A was outside a home.

As described above, the operation terminal displays the operation history by associating the details of one or more operations performed on an electrical device in the past (for a predetermined period counting backward from the present time) with an operation terminal which issued an instruction for the operation.

With this, it is possible to identify details of operations for a predetermined period counting backward from the present time and an operation terminal, in the operation history.

In addition, the operation terminal displays the items of the operation history in chronological order according to stored details of an operation, thereby making it possible to easily determine the chronological order of items of the operation history.

As described above, when the operation terminal which displays history of one or more operations for an electrical device communicates with the server which stores operation history transmitted from one or more operation terminals and information for identifying which one of the one or more operation terminals has issued an operation instruction to the electrical device and displays the operation history, it is possible to distinctively display operation history from the operation terminal which is present in the same home as the electrical device, or display only the operation history from the operation terminal which is present in the same home as the electrical device, together with the information for identifying which one of the one or more operation terminals has issued an operation instruction to the electrical device.

With this, when a state of running of an electrical device is displayed according to details of operations that are stored, it is possible to determine (i) information indicating which one of the one or more operation terminals has been used in operating the running and (ii) whether or not details of operations for the running have been carried out using an operation terminal that is present in the same home as the electrical device.

As described above, when the operation terminal which displays history of one or more operations for an electrical device communicates with the server which stores operation history transmitted from one or more operation terminals and information for identifying which one of the one or more operation terminals has issued an operation instruction to the electrical device, information indicating whether or not the operation has been performed by a timer operation is presented together with the information for identifying which one of the one or more operation terminals has issued an operation instruction to the electrical device, when displaying the operation history.

With this, it is possible to discriminate between an operation performed by a normal operation and an operation performed by a timer operation.

The format of an operation signal has been described with reference to FIG. 7, and here, details of (4) in-home/outside-home information 74 and (5) timer information 75 among the items of information will be described in detail.

In one method, an initial value of (4) in-home/outside-home information of an operation signal transmitted from the operation terminal 100 is set as “2”, it is determined as an outside-home communication when the operation signal passes through the server 200 in FIG. 2, and the server 200 changes the value to “3” which indicates outside-home. As another method, the value of (4) in-home/outside-home information may be set as “3” which indicates outside-home when the relay device 300 has received an operation signal from the server 200, and the value of (4) in-home/outside-home information may be set as “2” which indicates in-home when the relay device 300 has received an operation signal from the operation terminal 100. In addition, when the remote controller 500 transmits an operation signal, the value of (4) in-home/outside-home information is set as “0” which indicates remote controller, and transmitted.

With this, when an operation signal is transmitted from the operation terminal 100 to the electrical device 400, it is possible to include, in the history of the operation signal, information indicating whether or not the operation signal has been transmitted using the operation terminal 100 which is present in the same home as the electrical device 400, according to whether or not the operation signal has been transmitted from the operation terminal 100 to the electrical device 400 via the server 200, making it possible to acquire the information in a safety confirmation service, for example.

As yet another method, since an outside-home communications line (a public line, a data communication network, or an optical communication network) is used when an operation signal is transmitted from the operation terminal 100 to the server 200 in FIG. 2, the value of (4) in-home/outside-home information of the operation signal transmitted from the operation terminal 100 is set as “3” which indicates outside-home, and since an in-home communications line (a wireless LAN, Bluetooth (registered trademark), a low-power radio, or the like) is used when an operation signal is transmitted from the operation terminal 100 to the relay device 300, the value of (4) in-home/outside-home information of the operation signal transmitted from the operation terminal 100 is set as “2” which indicates in-home. Alternatively, when the relay device 300 receives an operation signal through an outside-home communications line, the value of (4) in-home/outside-home information may be set as “3” which indicates outside-home, and when the relay device 300 receives an operation signal through an in-home communications line, the value of (4) in-home/outside-home information may be set as “2” which indicates in-home.

With this, when an operation signal is transmitted from the operation terminal 100 to the electrical device 400, it is possible to include, in the history of the operation signal, information indicating whether or not the operation signal has been transmitted using the operation terminal 100 which is present in the same home as the electrical device 400, according to whether or not the operation signal has been transmitted via the outside-home communications line, making it possible to acquire the information in a safety confirmation service, for example.

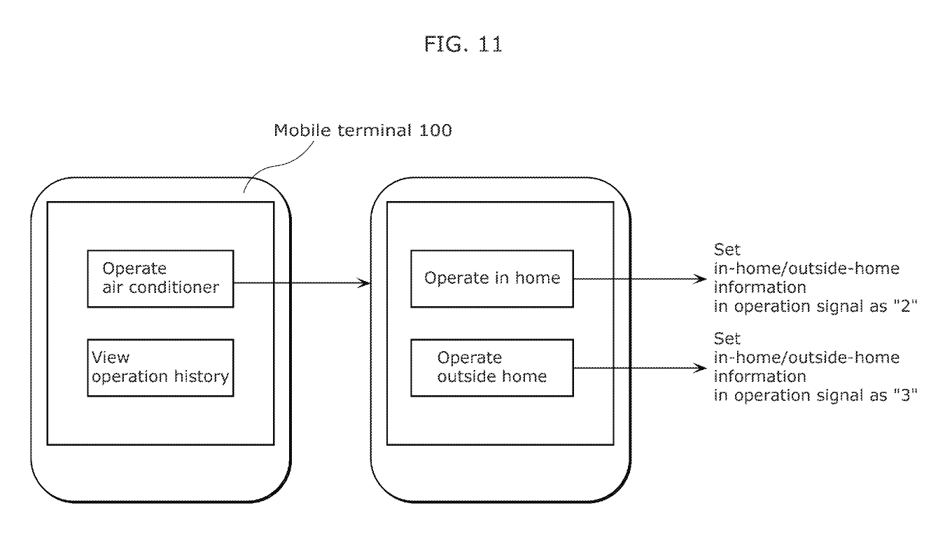

In addition, as yet another method, when the operation terminal 100 is used in an operation, a screen image is prepared which prompts a user to select between “to operate in a home” and “to operate from outside a home” on a screen for operating an air conditioner (electrical device) as illustrated in FIG. 11, and when the user selects “to operate in a home”, the operation terminal 100 transmits an operation signal to the relay device 300 with the in-home/outside-home information 74 in FIG. 7 being set as “2” which indicates in-home. When the user selects “to operate from outside a home”, the operation terminal 100 transmits an operation signal to the server 200 with the in-home/outside-home information 74 being set as “3” which indicates outside-home.

With this, when a user inputs details of an operation using the operation terminal 100, it is possible to include, in the history of the operation signal, information indicating whether or not the operation has been performed using the operation terminal which is present in the same home as the electrical device 400, according to whether the details of the operation have been inputted using the operation screen for operating in the same home as the electrical device 400 or the operation screen for operating from outside a home, making it possible to acquire the information in a safety confirmation service, for example. This method is effective also in a mode in which, when transmitting an operation signal from the operation terminal 100 in a home, the operation signal is transmitted using an outside-home communication (a public line, a data communication network, or the like) from the operation terminal 100 to the server 200, and from the server 200 to the electrical device 400 via the relay device 300 as in FIG. 3.

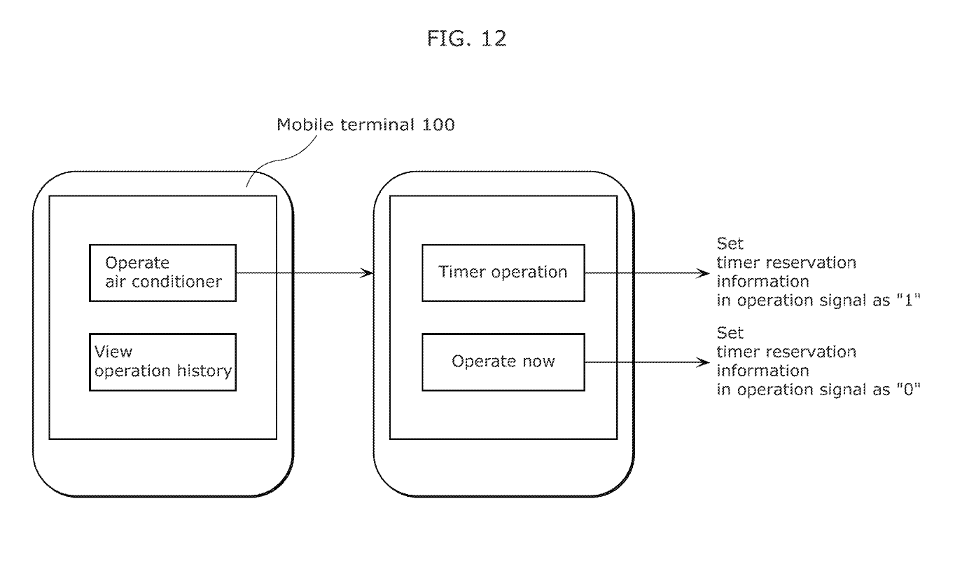

As with the screen image which prompts a user to select between “to operate in a home” and “to operate from outside a home” described above, as to the timer information 75 in FIG. 7, when operating using the operation terminal 100, a screen image which prompts the user to select between “timer operation” and “to operate now” (a real-time operation) is prepared on the screen for operating the air conditioner (electrical device) as in FIG. 12, and when the user selects “timer operation”, the operation terminal 100 transmits an operation signal with the timer information 75 being set as “1” which indicates a timer is on. When “to operate now” is selected, the operation terminal 100 transmits an operation signal with the timer information 75 being set as “0” which indicates a timer is off.

With this, it is possible to include, in the history of the operation signal, information indicating that the details of an operation have been inputted selecting which one of the operation screen image for setting a timer operation and the operation screen image for a real-time operation when a user has input the details of an operation using the operation terminal 100, making it possible to acquire the information in a safety confirmation service, for example.

As described above, according to the exemplary embodiment, details of at least one operation performed using any one of one or more operation terminals to operate an electrical device are stored, and when a state of running of the electrical device is displayed according to the details of at least one operation that are stored, (i) information indicating which one of the one or more operation terminals has been used in operating the running and (ii) information indicating whether or not the details of at least one operation for the running have been performed using, among the one or more operation terminals, one operation terminal that is present in a same home as the electrical device are presented.

With this, when a state of running of an electrical device is displayed according to the details of an operation that are stored, it is possible to determine (i) information indicating which one of the one or more operation terminals has been used in performing the operation and (ii) whether or not the details of an operation for the running have been carried out using an operation terminal that is present in the same home as the electrical device.

It is possible to store details of at least one operation performed using any one of one or more operation terminals to operate an electrical device; and when running of the electrical device is displayed according to the details of at least one operation that are stored, to present (i) information indicating which one of the one or more operation terminals has been used in operating the running and (ii) information indicating whether or not the running has been operated by a timer operation.

### Embodiment 2

The following describes a managing system according to the exemplary embodiment.

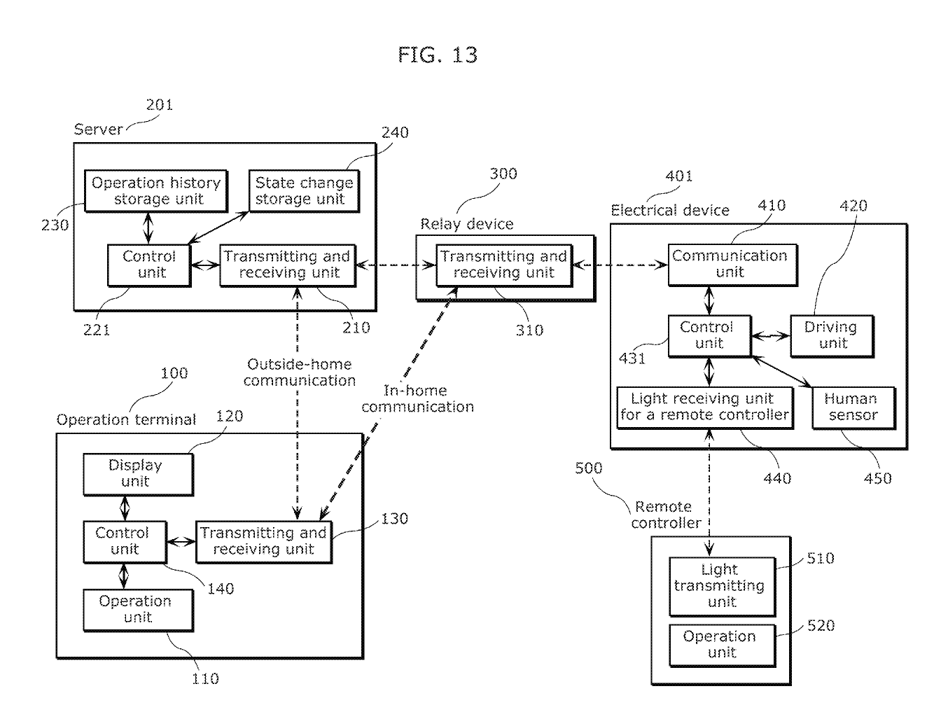

FIG. 13 illustrates a managing system according to the exemplary embodiment. The same reference numerals are assigned to the same elements as those in Embodiment 1 (FIG. 1) and detailed description for the elements will be omitted.

The overall operation flow is the same as those illustrated in FIG. 20 and FIG. 21 in Embodiment 1, and thus detailed description for the flow will be omitted. In a managing system according to the exemplary embodiment, details of at least one operation performed using any one of one or more operation terminals to operate an electrical device are stored, and when a state of running of the electrical device is displayed according to the details of at least one operation that are stored, (i) information indicating which one of the one or more operation terminals has been used in operating the running and (ii) information indicating whether or not the details of at least one operation for the running have been performed using, among the one or more operation terminals, one operation terminal that is present in a same home as the electrical device are presented.

The server 201 includes a state change storage unit 240 in addition to the configuration illustrated in FIG. 1. The state change storage unit 240 acquires and stores a change in a state of running of the electrical devices 400 with a method described later.

The control unit 221 controls the state change storage unit 240 in addition to the transmitting and receiving unit 210 and the operation history storage unit 230.

In addition, the electrical device 401 includes a human sensor 450 in addition to the configuration illustrated in FIG. 1.

The human sensor 450 is a sensor which detects a person in the vicinity of an electrical device and a motion of the person. For example, presence or absence of a person or the magnitude of a motion of a person is detected by an infrared sensor, a temperature sensor, an image sensor, and the like.

The control unit 431 controls the human sensor 450 in addition to the communication unit 410, the driving unit 420, and the light receiving unit for a remote controller 440. The control unit 431 transmits a result of detection performed by the human sensor 450 from the communication unit 410 to the server 200 via the relay device 300.

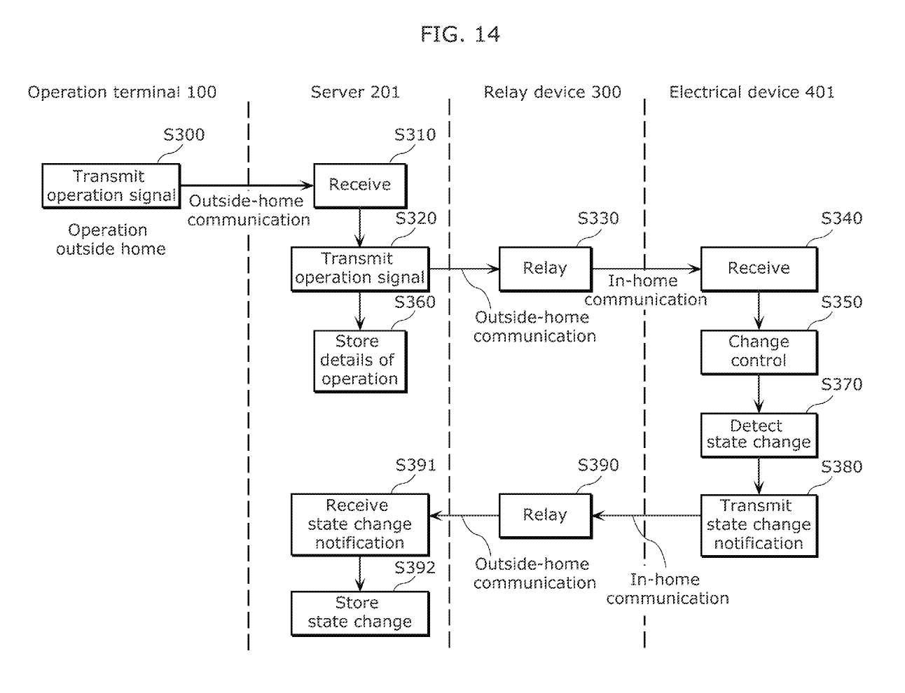

FIG. 14 is a sequence diagram explaining an operation for transmitting an operation signal from the operation terminal 100 outside a home and performing a remote control on the electrical device 401 in response to the operation signal. The same numerals are assigned to the same steps as Embodiment 1 (FIG. 3) and detailed description for the steps will be omitted.

In the electrical device 401, when the control unit 431 controls an operation of the driving unit 420 according to the operation details information included in the operation signal in Step S350, the state of running of the electrical device 401 is changed. The control unit 431 detects the state change in Step S370, and transmits a state change notification signal which indicates the details of state change (Step S380). At this time, the control unit 431 of the electrical device 401 adds a time at which the state change is detected as state change time information to the state change notification signal.

The relay device 300 receives the state change notification signal by the transmitting and receiving unit 310 in Step S390, and transmits the state change notification signal to the server 201.

The server 201 receives, by the transmitting and receiving unit 210, the state change notification signal transmitted from the relay device 300 in Step S391, stores the state change notification signal in the state change storage unit 240 to generate history of the state change notification.

As to the details of the state change notification signal, a state notification is a result with respect to an operation signal being a trigger, and thus formats of the operation signal and the state notification signal are similar. For example, with reference to the format of an operation signal illustrated in (a) of FIG. 8, a state change notification signal does not include destination information, source information, a terminal type, and in-home/outside-home information, but includes timer information, state information of an electrical device after change (controlled information), and state change time information indicating a time at which a state change occurred instead of the operation time information.

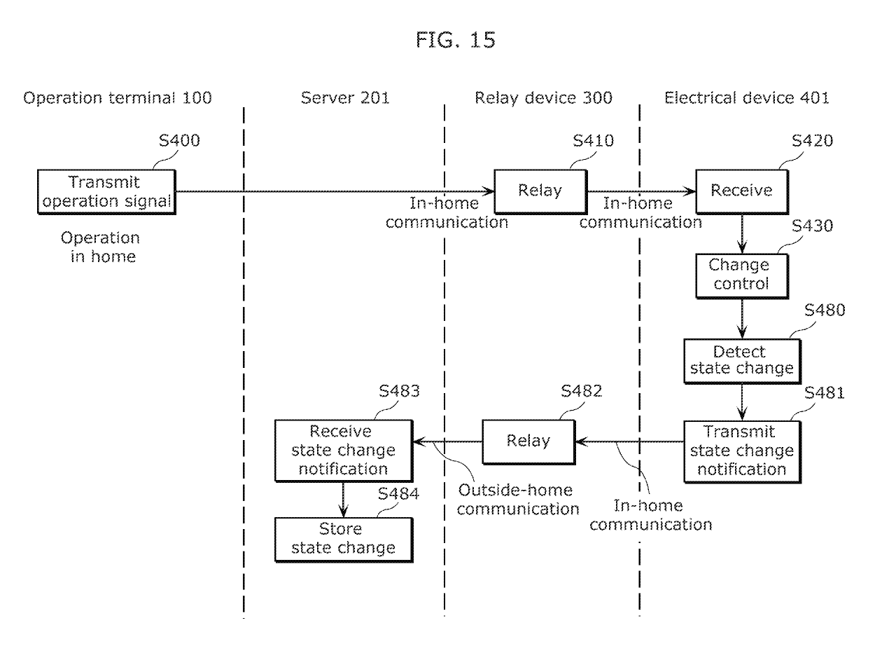

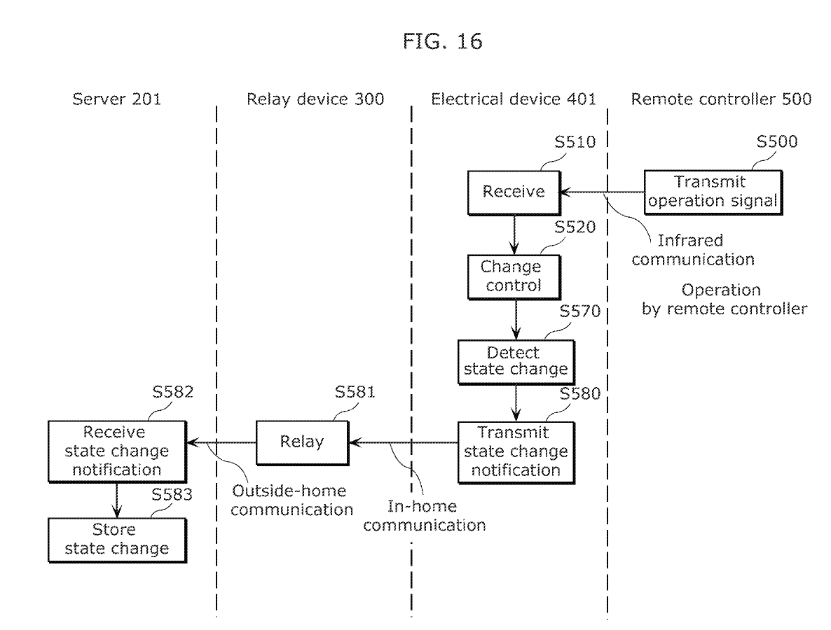

The state change of the electrical device 401 occurs when (i) an operation is performed by an outside-home operation terminal as in FIG. 14, (ii) an operation is performed by an in-home operation terminal as in FIG. 15, and (iii) an operation is performed by a remote controller as FIG. 16, each of which will be explained below.

FIG. 15 is a sequence diagram explaining an operation for transmitting an operation signal from the operation terminal 100 in a home and performing a remote control on the electrical device 401 in response to the operation signal. The same numerals are assigned to the same steps as Embodiment 1 (FIG. 4) and detailed description for the steps will be omitted.

To be specific, instead of transmitting the details of an operation (Step S440) in FIG. 4 of Embodiment 1, the control unit 431 detects a state change in Step S480, generates a state change notification signal, and transmits the state change notification signal from the communication unit 410 to the relay device 300 (Step S481). The relay device 300 receives the state change notification signal and transmits the state change notification signal to the server 201 (Step S482). The server 201 receives the state change notification signal in Step S483, stores the state change notification signal into the state change storage unit 240 to generate history of the state change notification (Step S484).

It is to be noted that, unlike Step S440 to Step S470 in FIG. 4 of Embodiment 1, the electrical device 401 does not transmit an operation signal to the server 201 in FIG. 15, and thus operation history is not generated in the operation history storage unit 230 in FIG. 15. The description for this point will be given later.

FIG. 16 is a sequence diagram explaining an operation for transmitting an operation signal from the remote controller 500 in a home and performing a remote control on the electrical device 401 in response to the operation signal. The same numerals are assigned to the same steps as Embodiment 1 (FIG. 5) and detailed description for the steps will be omitted.

To be specific, instead of transmitting the details of an operation (Step S530) in FIG. 5 of Embodiment 1, the control unit 431 detects a state change in Step S570, generates a state change notification signal, and transmits the state change notification signal from the communication unit 410 to the relay device 300 (Step S580). The relay device 300 receives the state change notification signal and transmits the state change notification signal to the server 201 (Step S581). The server 201 receives the state change notification signal in Step S582, stores the state change notification signal into the state change storage unit 240 to generate history of the state change notification (Step S583).

It is to be noted that, unlike Step S530 to Step S560 in FIG. 5 of Embodiment 1, the electrical device 401 does not transmit an operation signal to the server 201 in FIG. 16, and thus operation history is not generated in the operation history storage unit 230 in FIG. 16. The description for this point will be given later.

As described above, results of all of the operations (a state change of the electrical device 401) when an operation has been carried out using an outside-home operation terminal, an in-home operation terminal, and a remote controller are stored in the state change storage unit 240.

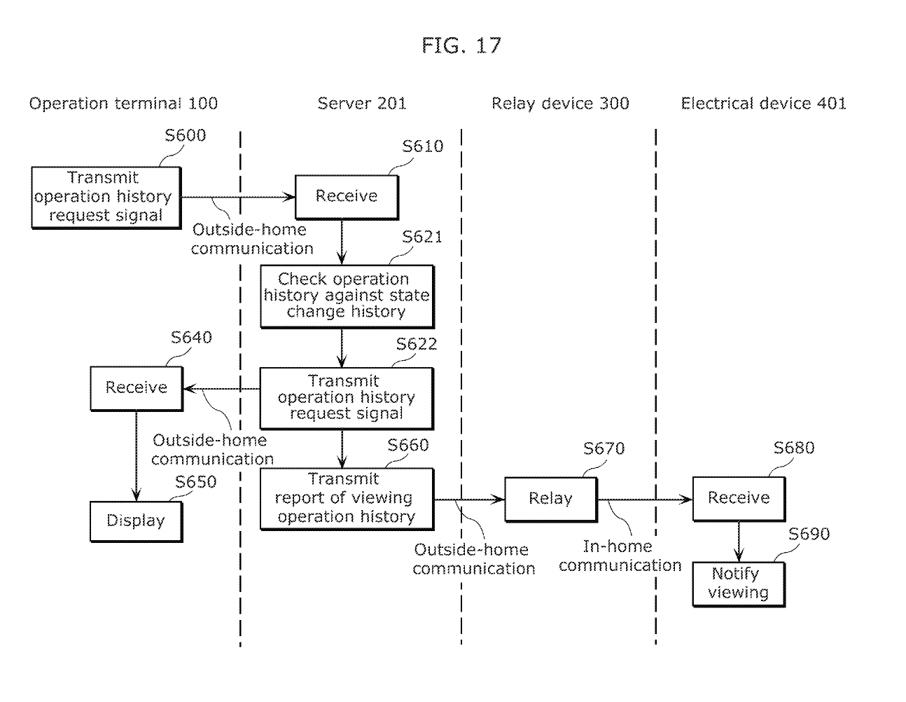

Next, FIG. 17 illustrates a sequence when viewing operation history on the operation terminal 100 using operation history and history of state change notification generated in the server 201. The same numerals are assigned to the same steps as Embodiment 1 (FIG. 6) and detailed description for the steps will be omitted.

The control unit 220 of the server 201 checks the operation history stored in the operation history storage unit 230 against the history of the state change notification stored in the state change storage unit 240 in Step S621, thereby making it possible to generate operation history in which the history of operations using an outside-home operation terminal is discriminated from the history of operations using an in-home operation terminal or a remote controller.

More specifically, the operation history of an operation which is operated from an outside-home operation terminal and the history of a state change resulting from the operation are stored in both of the operation history storage unit 230 and the state change history storage unit 240 of the server 201. On the other hand, the operation history of an operation which is operated from an in-home operation terminal or a remote controller is not stored in the operation history storage unit 230 of the server 201, and only the history of the state change notification that is the result of the operation is stored in the state change storage unit 240.

For that reason, by checking the operation history against the history of the state change notification, it is possible to know that an operation of which the operation history and the history of state change notification are stored in association with each other has been operated by the outside-home operation terminal. In addition, as to history of which only the history of state change notification is stored and the operation history is not stored, it is possible to know that a triggering operation is operated by the in-home operation terminal or the remote controller.

As described above, it is possible to discriminate the operation history of an operation that has been operated by the outside-home operation terminal from the operation history of an operation that has been operated by the in-home operation terminal or the remote controller, thereby making it possible to add, to the history of state change notification, information corresponding to (4) in-home/outside-home information of the operation history illustrated in (a) in FIG. 8 of Embodiment 1. However, detailed information on the operation history of an operation that has been operated by the in-home operation terminal or the operation history of an operation that has been operated by the remote controller cannot be acquired.

The server 201 transmits the operation history resulting from checking the operation history of an operation that has been operated by the outside-home operation terminal (operation history stored in the operation history storage unit 230) against the operation history of an operation that has been operated by the in-home operation terminal or the remote controller (operation history) resulting from adding information corresponding to (4) in-home/outside-home information to the history of state change notification stored in the state change history storage unit 240) as described above, to the operation terminal 100 to cause the operation terminal 100 to display the operation history (Steps S622, S640, and S650).

As another embodiment, when the control unit 431 detects a state change in Step S370 of FIG. 14 and the communication unit 410 transmits the state change notification signal indicating details of the state change to the relay device 300, the control unit 431 of the electrical device 401 may generate the state change notification signal by adding a time when the state change has been detected (state change time information) to the operation signal received in S420. The control unit 431 of the electrical device 401 generates the state change notification signal by adding the state change time information to the operation signal received, in Step S480 of FIG. 15 and Step S570 in FIG. 16 as well.

According to this mode, since the destination information, the source information, the terminal type, and the in-home/outside-home information of the operation signal that has triggered the state change are included in the state change notification signal, it is possible to display, on the operation terminal 100, the operation history of the operation that has been operated in a home, outside a home, and using a remote controller as in Embodiment 1.

The process of discriminating the in-home/outside-home information of the details of an operation is the same as that of Embodiment 1. In one method, an initial value of (4) in-home/outside-home information of an operation signal transmitted from the operation terminal 100 is set as “2”, it is determined as an outside-home communication when the operation signal passes through the server 200 in FIG. 13, and the server 200 changes the value to “3” which indicates outside-home. As another method, the value of (4) in-home/outside-home information may be set as “3” which indicates outside-home when the relay device 300 has received an operation signal from the server 200, and the value of (4) in-home/outside-home information may be set as “2” which indicates in-home when the relay device 300 has received an operation signal from the operation terminal 100. In addition, when the remote controller 500 transmits an operation signal, the value of (4) in-home/outside-home information is set as “0” which indicates a remote controller, and transmitted.

With this, it is possible to include, in the history of the operation signal, information indicating whether or not the operation signal has been transmitted using the operation terminal 100 which is present in the same home as the electrical device 400, according to whether or not the operation signal has been transmitted from the operation terminal 100 to the electrical device 400 via the server 200 when an operation signal is transmitted from the operation terminal 100 to the electrical device 400, making it possible to acquire the information in a safety confirmation service, for example.

As yet another method, since an outside-home communications line (a public line, a data communication network, or an optical communication network) is used when an operation signal is transmitted from the operation terminal 100 to the server 200 in FIG. 13, the value of (4) in-home/outside-home information of the operation signal transmitted from the operation terminal 100 is set as “3” which indicates outside-home, and since an in-home communications line (a wireless LAN, Bluetooth (registered trademark), a low-power radio, or the like) is used when an operation signal is transmitted from the operation terminal 100 to the relay device 300, the value of (4) in-home/outside-home information of the operation signal transmitted from the operation terminal 100 is set as “2” which indicates in-home. Alternatively, when the relay device 300 receives an operation signal through an outside-home communications line, the value of (4) in-home/outside-home information may be set as “3” which indicates outside-home, and when the relay device 300 receives an operation signal through an in-home communications line, the value of (4) in-home/outside-home information may be set as “2” which indicates in-home.

With this, it is possible to include, in the history of the operation signal, information indicating whether or not the operation signal has been transmitted using the operation terminal 100 which is present in the same home as the electrical device 400, according to whether or not the operation signal has been transmitted via the outside-home communications line when the operation signal has been transmitted from the operation terminal 100 to the electrical device 400, making it possible to acquire the information in a safety confirmation service, for example.

In addition, as yet another method, when the operation terminal 100 is used in an operation, a screen image which prompts a user to select between “to operate in a home” or “to operate from outside a home” is prepared on a screen for operating an air conditioner (electrical device) as illustrated in FIG. 11 of Embodiment 1, and when the user selects “to operate in a home”, the operation terminal 100 transmits an operation signal to the relay device 300 with the in-home/outside-home information 74 in FIG. 7 being set as “2” which indicates in-home. When the user selects “to operate from outside a home”, the operation terminal 100 transmits an operation signal to the server 200 with the in-home/outside-home information 74 being set as “3” which indicates outside-home.

This method is effective also in a mode in which, when transmitting an operation signal from the operation terminal 100 in a home, the operation signal is transmitted using an outside-home communication (a public line or a data communication network) from the operation terminal 100 to the server 201, and from the server 201 to the electrical device 400 via the relay device 300 as in FIG. 14.

With this, it is possible to include, in the history of the operation signal, information indicating whether or not the operation has been performed using the operation terminal which is present in the same home as the electrical device 400, according to whether the details of an operation have been inputted using the operation screen for operating in the same home as the electrical device 400 or the operation screen for operating outside a home when a user inputs details of an operation using the operation terminal 100, making it possible to acquire the information in a safety confirmation service, for example.

The process of determining timer information is the same as that of Embodiment 1. When operating using the operation terminal 100, a screen image which prompts the user to select between “timer operation” and “to operate now” (a real-time operation) is prepared on the screen for operating the air conditioner (electrical device) as in FIG. 12, and when the user selects “timer operation”, the operation terminal 100 transmits an operation signal with the timer information 75 being set as “1” which indicates a timer is on. When “to operate now” is selected, the operation terminal 100 transmits an operation signal with the timer information 75 being set as “0” which indicates a timer is off.

With this, it is possible to include, in the history of the operation signal, information indicating that the details of an operation have been inputted selecting which one of the operation screen for setting a timer operation and the operation screen for a real-time operation has been selected to input details of an operation when a user has input the details of the operation using the operation terminal 100, making it possible to acquire the information in a safety confirmation service, for example.

According to the exemplary embodiment described above, details of one or more operations performed using any one of one or more operation terminals for operating an electrical device are stored, and when a state of running of the electrical device is displayed according to the stored details of one or more operations, (i) information indicating which one of the one or more operation terminals has been used in operating the running and (ii) information indicating whether or not the details of the operation for the running have been carried out using, among the one or more operation terminals, one operation terminal which is present in the same home as the electrical device.

With this, when a state of running of an electrical device is displayed according to details of operations that are stored, it is possible to determine (i) information indicating which one of operation terminals has been used in operating the running and (ii) whether or not details of operations for the running have been carried out using an operation terminal that is present in the same home the electrical device.

In addition, details of one or more operations performed using any one of one or more operation terminals for operating an electrical device are stored, and when running of the electrical device is displayed according to the stored details of operations, (i) information indicating which one of the one or more operation terminals has been used in operating the running and (ii) information indicating whether or not the running is operated by a timer operation are presented. With this, it is possible to discriminate between an operation performed by a normal operation and an operation performed by a timer operation.

In addition, a result of detection performed by the human sensor 450 may be included in the state change notification signal as the operation history. The human sensor 450 stores a result of detection at predetermined intervals, and the control unit 431 transmits the state change notification signal including the result of detection performed by the human sensor to the relay device 301, when there is a change in a state.

Then, when checking history of the state change notification against the operation history in Step S621 of FIG. 17, the operation history including the result of detection performed by the human sensor 450 is transmitted to the operation terminal 100 and displayed (Step S650). With this, it is possible to acquire, together with the operation history, information indicating whether or not there was someone in the vicinity of the electrical device 401 when there was a change in the state. Alternatively, the result of detection performed by the human sensor 450 may be periodically transmitted from the electrical device 401 to the server 201 via the relay device 301 as a human sensor detection signal separately from the state change notification signal, or may be transmitted when there is a change in the result of detection performed by the human sensor.

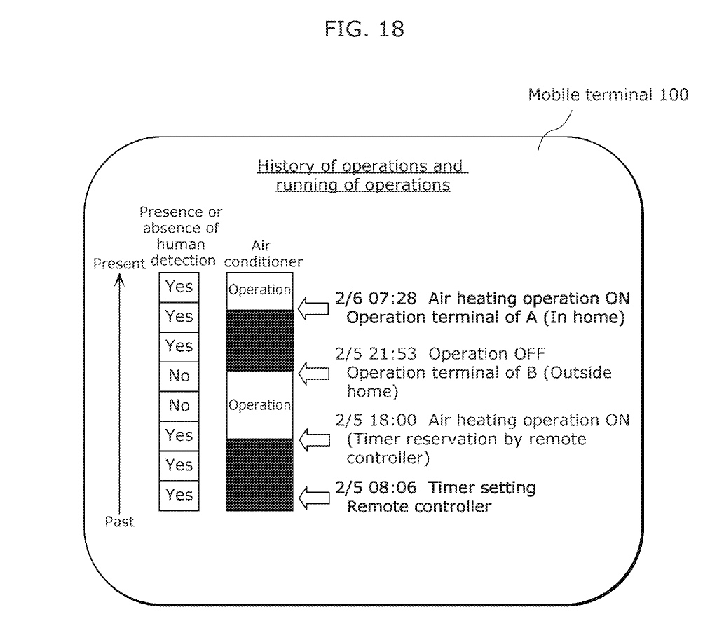

FIG. 18 illustrates a display of history of operations and running of operations of an air conditioner, which is generated using the operation history and the state change history.

Based on the operation times of operation signals and operation running times of an the electrical device (state change time information), items for a predetermined period counting backward from the present time (for the past 48 hours, for example) are displayed. This allows a viewer to know: whether or not the air conditioner is running at present; who has turned on the air conditioner and whether the operation has been performed in a home or outside a home; and when timer setting has been performed and when operation running is started in the case of a timer operation, with the history of operations and the history of running of the operations being associated with each other.

In addition, a result of detection performed by the human sensor may be displayed together. Although results of human detection are represented by Yes and No in FIG. 18, results of human detection may be represented in multiple phases, such as strong, middle, weak, and non.

As with FIG. 9 according to Embodiment 1, since an item of the operation history transmitted from the operation terminal which is present in a home is distinctively displayed by, for example, highlighting with italics, bold, or colored characters, it is possible for a viewer to know that user A was at home at the time. Since an item of the timer operation is distinctively displayed by, for example, highlighting with italics, bold, or different colored characters, it is possible for a viewer to understand that the electrical device 400 was not actually operated by A at the time when the electrical device 400 was turned on or off, but a timer was set previously at a different time. With distinctive display such as highlighting by color when the result of detection performed by the human sensor is Yes, it is possible for a viewer to know the situation in which the air conditioner is running but there is not anyone there, or the air conditioner is not running but there is a person.

As described above, when the operation terminal which displays history of one or more operations for an electrical device communicates with the server which stores operation history transmitted from one or more operation terminals and information for identifying which one of the one or more operation terminals has issued an operation instruction to the electrical device, it is possible, when the operation history is displayed, to distinctively display operation history from the operation terminal which is present in the same home as the electrical device, or display only the operation history from the operation terminal which is present in the same home as the electrical device, together with the information for identifying which one of the one or more operation terminals has issued an operation instruction to the electrical device.

In addition, when the operation history is displayed, information indicating whether or not the running has been operated by a timer operation is presented together with the information for identifying which one of the one or more operation terminals has issued an operation instruction to the electrical device. With this, it is possible to discriminate between an operation performed by a normal operation and an operation performed by a timer operation.

It is to be noted that operation history of the operation terminal which is present outside a home may be excluded from display of operation history, and only an operation performed by an operation terminal or a remote controller which are present in the home may be displayed, thereby making it possible to know a time when someone was in the home. In addition, only the operation history related to a specific operation terminal (a user who owns it) may be displayed, thereby making it possible to know a time when user A was in a home and a time when user A was outside a home.

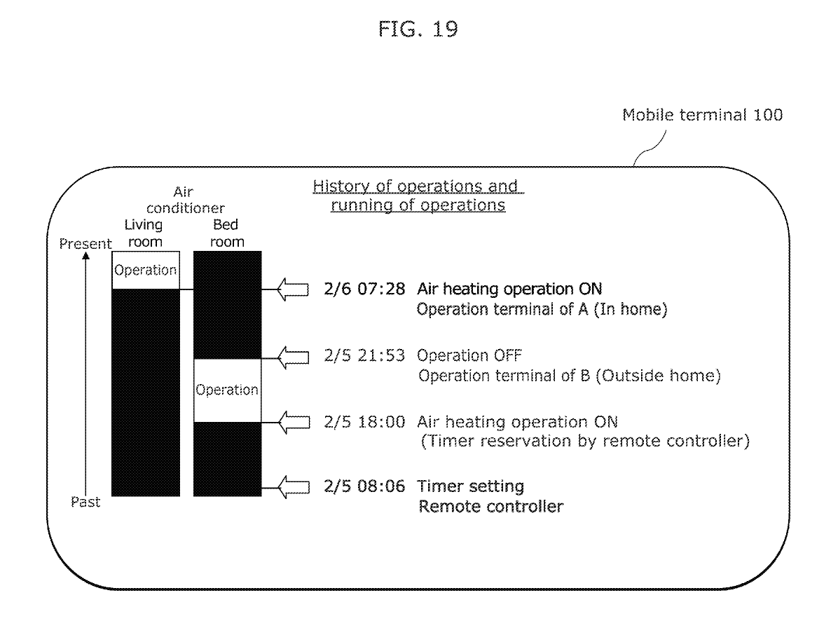

Here, the human sensor 450 is not necessarily required in Embodiment 2. FIG. 19 illustrates a display of generated history of operations and operation running when there are a plurality of electrical devices (air conditioners). In addition, although it is not illustrated, a human sensor may be included in the configuration according to Embodiment 1, details of operation including a result of detection performed by the human sensor may be transmitted from the electrical device, and the result of detection performed by the human sensor may be displayed together with the operation history on the operation terminal 100 as in FIG. 18.

It is to be noted that, although the exemplary embodiments have been described as managing systems according to Embodiments 1 and 2 above, this may be implemented as an invention of a method of managing the managing system including an electrical device, one or more operation terminals for operating the electrical device by transmitting an operation signal, and a server for storing history of an operation from the operation terminal, and in the method of managing the managing system, details of an operation for the electrical device are displayed on the operation terminal, and information for identifying which one of the one or more operation terminals has issued an operation instruction for the electrical device, or unique information associated with the operation terminal is displayed.

In addition, with a program for a managing system including: one or more electrical devices; one or more operation terminals for operating the one or more electrical devices by transmitting an operation signal; and a server for storing operation history from the one or more operation terminals, the program may cause a computer to function as a managing system in which, when the one or more operation terminals communicate with the server and display the operation history, the one or more operation terminals display, together with information for identifying which one of the one or more operation terminals has issued an operation instruction to the one or more electrical devices, (i) distinctively the operation history from, among the one or more operation terminals, one operation terminal which is present in a same home as the electrical device, or (ii) only the operation history from the operation terminal which is present in the same home as the electrical device.

With this, when operation history of an electrical device is displayed, it is possible to determine (i) information indicating which one of one or more operation terminals has been used in operating the running and (ii) whether or not details of an operation for the running have been carried out using, among the one or more operation terminals, one operation terminal which is present in the same home as the electrical device.

In addition, the display modes described in the exemplary embodiments can be applied to a display terminal which does not emit an operation signal, including an operation terminal.

It is to be noted that, although an air conditioner has been used for describing the electrical device in the exemplary embodiments, the electrical device is not limited to the air conditioner, and may be a television set, a recorder, an air handling unit, an air cleaner, a refrigerator, a washing machine, a rice cooker, a microwave oven, a hot water dispenser, a toilet seat warmer, a vacuum cleaner, HEMS (home energy management system), and the like. In addition, the exemplary embodiments are applicable not only to the safety confirmation service but also to a system in which operation history of a managing system is stored and viewed.

Each of the structural elements in each of the above-described embodiments may be configured in the form of an exclusive hardware product, or may be realized by executing a software program suitable for each of the structural elements. Each of the structural elements may be realized by means of a program executing unit, such as a CPU and a processor, reading and executing the software program recorded on a recording medium such as a hard disk or a semiconductor memory. Here, the software program for realizing the managing system and the like according to each of the exemplary embodiments is a program described below.

That is, the program causes a computer to execute a method of managing an electrical device, including: storing details of at least one operation performed using any one of one or more operation terminals to operate an electrical device; and when a state of running of the electrical device is displayed according to the details of at least one operation that are stored, presenting (i) information indicating which one of the one or more operation terminals has been used in operating the running and (ii) information indicating whether or not the details of at least one operation for the running have been performed using, among the one or more operation terminals, one operation terminal that is present in a same home as the electrical device.

It should be noted that although the method for managing an electrical device according to one ore more aspects is described based on the aforementioned exemplary embodiments, the present invention is obviously not limited to such exemplary embodiments. Other forms in which various modifications apparent to those skilled in the art are applied to Embodiment, or forms structured by combining structural elements of different aspects of Embodiment may be included within the scope of the one or plurality of aspects, unless such changes and modifications depart from the scope of the present invention.

### INDUSTRIAL APPLICABILITY

As described above, the method of managing an electrical device, a managing system, an electrical device, an operation terminal, and a program according to the present invention can be applied to a system which is not limited to a domestic use, a business use, or an office use, and is capable of remotely operating, from outside a home, an electrical device which is present in a home and is connected to a network. In addition, the exemplary embodiments are applicable not only to the safety confirmation service but also to a system in which operation history of a managing system is stored and viewed.

### REFERENCE SIGNS LIST

100, 101 operation terminal
110 operation unit
130, 210, 310 transmitting and receiving unit
200, 201 server
230 operation history storage unit
300 relay device
400, 401, 402 electrical device
410 communication unit
500 remote controller
520 operation unit

1. A method of managing an electrical device, comprising:
storing details of at least one operation performed using any one of one or more operation terminals to operate an electrical device; and
when a state of running of the electrical device is displayed according to the details of at least one operation that are stored, presenting (i) information indicating which one of the one or more operation terminals has been used in operating the running and (ii) information indicating whether or not the details of at least one operation for the running have been performed using, among the one or more operation terminals, one operation terminal that is present in a same home as the electrical device.

2. The method of managing an electrical device according to claim 1,
wherein the information indicating whether or not the details of at least one operation for the running have been performed using, among the one or more operation terminals, one operation terminal that is present in a same home as the electrical device is determined according to which one of (i) an operation screen image for performing an operation in the same home as the electrical device and (ii) an operation screen image for performing an operation outside the home has been selected by a user to input the details of at least one operation, when the user has input the details of at least one operation for the running using the one of the one or more operation terminals.

3. The method of managing an electrical device according to claim 1,
wherein the information indicating whether or not the details of at least one operation for the running have been performed using, among the one or more operation terminals, one operation terminal that is present in a same home as the electrical device is determined according to whether or not an operation signal for the running has been transmitted from the one of the one or more operation terminals to the electrical device via an outside-home communications line.

4. A method of managing an electrical device, comprising:
storing details of at least one operation performed using any one of one or more operation terminals to operate an electrical device; and
when running of the electrical device is displayed according to the details of at least one operation that are stored, presenting (i) information indicating which one of the one or more operation terminals has been used in operating the running and (ii) information indicating whether or not the running has been operated by a timer operation.

5. The method of managing an electrical device according to claim 4,
wherein the information indicating whether or not the running has been operated by a timer operation is determined according to which one of (i) an operation screen image for setting the timer operation and (ii) an operation screen image for a real-time operation has been selected by a user to input the details of at least one operation when the user has input the details of at least one operation for the running using the one of the one or more operation terminals.

6. The method of managing an electrical device according to claim 2,
wherein the state of running of the electrical device is displayed in chronological order according to the details of at least one operation that are stored.

7. A managing system comprising: one or more electrical devices; one or more operation terminals for operating the one or more electrical devices by transmitting an operation signal; and a server for storing operation history from the one or more operation terminals,
wherein when the one or more operation terminals communicate with the server and display the operation history, the one or more operation terminals display, together with information for identifying which one of the one or more operation terminals has issued an operation instruction to the one or more electrical devices, (i) distinctively the operation history from, among the one or more operation terminals, one operation terminal that is present in a same home as the one or more electrical devices, or (ii) only the operation history from the operation terminal that is present in the same home as the one or more electrical devices.

8. The managing system according to claim 7,
wherein whether or not an operation signal has been transmitted from the same home as the one or more electrical devices is determined according to whether or not the operation signal has been transmitted via the server when the one or more operation terminals have transmitted the operation signal to the one or more electrical devices.

9. A managing system comprising: one or more electrical devices; one or more operation terminals for operating the one or more electrical devices by transmitting an operation signal; and a server for storing operation history from the one or more operation terminals,
wherein when the one or more operation terminals communicate with the server and display the operation history, the one or more operation terminals display distinctively operation history of a timer operation, together with information for identifying which one of the one or more operation terminals has issued an operation instruction to the one or more electrical devices.

10. An electrical device which receives an operation signal from an operation terminal to control an operation,
the electrical device discriminating between an operation signal received via a server and an operation signal received without involving the server, and transmitting, to the server, information of the operation signal received without involving the server, to add the information to history of the operation signal stored by the server.

11. An operation terminal for displaying operation history of one or more electrical devices,
the operation terminal communicating with a server that stores the operation history from one or more operation terminals and information for identifying which one of the one or more operation terminals has issued an operation instruction, and
when the operation history is displayed, displaying, together with the information for identifying which one of the one or more operation terminals has issued an operation instruction, (i) distinctively the operation history from, among the one or more operation terminals, one operation terminal that is present in a same home as the electrical device, or (ii) only the operation history from the operation terminal that is present in the same home as the electrical device.

12. A non-transitory computer-readable recording medium on which a program for a managing system including: one or more electrical devices; one or more operation terminals for operating the one or more electrical devices by transmitting an operation signal; and a server for storing operation history from the one or more operation terminals is recorded,
the program causing a computer to function as the managing system in which, when the one or more operation terminals communicate with the server and display the operation history, the one or more operation terminals display, together with information for identifying which one of the one or more operation terminals has issued an operation instruction to the one or more electrical devices, (i) distinctively the operation history from, among the one or more operation terminals, one operation terminal which is present in a same home as the electrical device, or (ii) only the operation history from the operation terminal which is present in the same home as the electrical device.
